(19) United States
(12) Patent Application Publication
(10) Pub. No.: US 2019/0037821 A1
(43) Pub. Date: Feb. 7, 2019

(54) METHOD OF EXTRACTING AQUATIC ANIMALS FROM AN APPARATUS

(71) Applicant: THE NEW ZEALAND INSTITUTE FOR PLANT AND FOOD RESEARCH LIMITED, Mt Albert, Auckland (NZ)

(72) Inventors: Alistair Renfrew JERRETT, Nelson (NZ); Gerard John JANSSEN, Richmond (NZ); Suzanne Elaine BLACK, Nelson (NZ); Damian MORAN, Nelson (NZ)

(73) Assignee: The New Zealand Institute for Plant and Food Research Limited, Mt Albert, Auckland (NZ)

(21) Appl. No.: 15/759,668

(22) PCT Filed: Sep. 8, 2016
(86) PCT No.: PCT/NZ2016/050143

§ 371 Date: Mar. 13, 2018

(30) Foreign Application Priority Data
Sep. 18, 2015 (NZ) 712511

(51) Int. Cl. A01K 75/00; A01K 73/02

(52) U.S. Cl. CPC A01K 75/00; A01K 73/02

(57) ABSTRACT

A method for extracting aquatic animals from an apparatus (102) containing aquatic animals. The apparatus has a body with an open end (102a), a substantially closed end (102b), and one or more side walls (102c) between the open end and the substantially closed end. At least a major portion of the side wall(s) are in the form of a flexible membrane, and at least a major portion of the side wall(s) and the substantially closed end are substantially impervious to water. The method involves arranging the apparatus (102) with an open end (102a) of the apparatus positioned higher than a substantially closed end (102b) of the apparatus, introducing a flow of liquid into an interior region of the apparatus proximal the substantially closed end, and using the introduced flow of liquid to transport aquatic animals contained in the apparatus, out of the open end (102a) of the apparatus.

### FIELD OF THE INVENTION

This invention relates to a method of extracting aquatic animals from an aquatic animal harvesting or transporting apparatus.

### BACKGROUND

Aquatic animal harvesting apparatuses such as fishing and trawling nets traditionally comprise a net that is towed under water by a towing vessel such as a boat. The nets comprise a mouth, lengthener, and a trailing ‘cod end’. When a traditional net is hauled out of the water and onto a boat, it must be lifted above the deck of the vessel. The animals are often crushed against each other and the edge of the boat as the water drains from the net, damaging the catch.

This tissue damage can limit the utility and value of organisms caught. The impacting of the animals with each other also causes stress to the captured animals. This stress is undesirable as it causes autolytic spoilage, reducing the quality of the catch. It is known in meat processing that minimising stress to animals before slaughter improves the quality of the meat. The damage also negatively affects the survival of unwanted animals if they are returned to the sea or retained live.

Further, lifting the full trawl net and catch above the deck of the vessel requires heavy lifting hydraulic systems, with the size of the hydraulic system and the size of the vessel limiting the size of the catch that can be bought onboard. Further, lifting such a large weight above the board of the vessel is associated with a number of safety hazards and has the potential to cause vessel stability issues, particularly on side lifting vessels. Current cod ends sizes are limited by the ability of the vessel to lift the bag and process the harvested contents.

In addition, when a catch is brought on board in a traditional net, or left in a pile onboard while it is sorted, it is exposed. Detritus from the catch attracts predators and scavengers such as birds, seals, sea lions, sharks and fur seals.

Some arrangements use suction pumps to suck animals from a trawl under water, up to the vessel. Such suction systems are generally cumbersome due to the stiffness of any piping to accommodate the negative suction pressures, are difficult to correctly position underwater and operate, and are susceptible to mechanical failure due to their complexity. Suction fish pumps are also poor for use near the surface or under any condition that may cause a break in the vacuum.

In addition, suction systems can damage captured animals in several ways. For example, animals can be damaged through contact with mechanical components such as piping and valves, and through close contact with other fish. The high suction forces can cause haemorrhaging. Suction systems require the fish to present themselves axially to the water flow and pipe and are susceptible to blocking when pumping mixed species; for example, rays, sharks, dogfish, puffer fish, etc. There is therefore a need for an apparatus and method that enable aquatic animals to be removed from aquatic animal harvesting or transporting devices, while minimising both physical damage to the aquatic animals and the stress induced in the removal process to improve the quality of the aquatic animals.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

It is an object of at least a preferred embodiment of the present invention to provide a method of extracting aquatic animals from an aquatic animal transporting or harvesting apparatus that addresses at least one of the abovementioned disadvantages. It is an additional or alternative object of at least a preferred embodiment of the present invention to provide an apparatus for use with the method of extracting aquatic animals. It is an additional or alternative object of at least a preferred embodiment of the present invention to at least provide the public with a useful choice.

### SUMMARY OF THE INVENTION

In a first aspect, the invention broadly consists in a method for extracting aquatic animals from an apparatus containing aquatic animals. The apparatus comprises a body with an open end and a substantially closed end and one or more side walls between the open end and the substantially closed end. At least a major portion of the side wall(s) comprise a flexible membrane, and at least a major portion of the side wall(s) and the substantially closed end are substantially impervious to water. The method comprises arranging the apparatus with the open end of the apparatus positioned higher than the substantially closed end; introducing a flow of liquid into an interior region of the apparatus proximal the substantially closed end; and using the introduced flow of liquid to transport aquatic animals contained in the apparatus, out of the open end of the apparatus.

The apparatus may comprise a baffle defining a channel having a channel inlet and a channel outlet, the channel outlet proximal the substantially closed end of the apparatus body. The method may comprise introducing liquid into the channel via the channel inlet, thereby causing liquid to flow along the channel, wherein the flow of liquid into the interior region of the apparatus proximal the substantially closed end is provided by way of the channel outlet.

The channel inlet may be positioned proximal the open end of the apparatus body. The channel may be an elongate channel, and may extend along at least a major length of the apparatus body.

Liquid may be introduced into the channel inlet by pumping water into the channel inlet from a pump. For example a propeller-type pump. The water may be pumped from the sea or from another source such as a water supply on a vessel into the apparatus. The pumped water may be cooled or may be otherwise treated.

In an embodiment, the channel inlet may be positioned in an interior of the apparatus body. For example, in the open end of the apparatus body. The method may comprise inserting an outlet from a pump into the channel inlet and/or coupling the outlet from the pump to the channel inlet, through the open end of the apparatus body.

In an alternative embodiment, the channel inlet is provided in the or one side wall of the apparatus, for example, through an opening in said side wall. The method may comprise inserting an outlet from a pump into the channel inlet and/or coupling the outlet from the pump to the channel inlet, from a side of the apparatus.

In an embodiment, the flow of liquid introduced into the interior region of the apparatus proximal the substantially closed end applies a positive pressure to the contents of the apparatus, resulting in a net flow of liquid from the substantially closed end of the apparatus to the open end. That net flow is advantageously sufficient to transport at least some aquatic animals contained in the apparatus, towards and out of the open end of the apparatus.

The method may comprise varying a flow rate of liquid into the channel to vary the rate of extraction of aquatic animals or to control the type of aquatic animals that are extracted. The flow rate variation may be manual or automatic by way of a controller, for example, to a pre-defined flow rate or sequence.

An embodiment of the method comprises arranging the apparatus in a substantially upright configuration. In an embodiment, the substantially closed end of the apparatus remains in the body of water while the aquatic animals are extracted.

An embodiment of the method comprises emptying at least some of any aquatic animals remaining in the apparatus, after using the introduced flow of liquid to transport aquatic animals contained in the apparatus out of the open end of the apparatus. An embodiment of the method comprises lifting the substantially closed end of the apparatus to drain at least some of any remaining aquatic animals out of the open end of the apparatus. An alternative embodiment of the method comprises inverting at least the substantially closed end of the apparatus to drain at least some of any remaining aquatic animals out of the open end of the apparatus.

The method may comprise securing or restraining the apparatus or a portion of the apparatus prior to introducing a flow of liquid into the apparatus, to reduce movement of the apparatus. For example, the method may comprise securing or restraining the apparatus or a portion of the apparatus relative to a marine vessel. In an embodiment, the body of the apparatus is restrained by a chute or cradle

Aquatic animals from the apparatus may be extracted to a marine vessel or to another facility, for example, for sorting and processing. The extracted animals may be passed over a sorting grid or grill to remove undersize or juvenile animals.

In an embodiment, the apparatus body and substantially closed end are substantially water tight. However, alternatively, the substantially closed end and/or the body may have seams, apertures, flaps, and/or drainage holes that are water permeable, such that as the apparatus is raised and/or as liquid is pumped into the apparatus, some liquid seeps from the seams and/or apertures. Apertures in the body may be configured to bleed entrained air from the apparatus.

In an embodiment, the method forms part of a method of harvesting aquatic animals. The method comprises providing an apparatus comprising a body with an open end, a substantially closed end, and one or more side walls between the open end and the substantially closed end, wherein at least a major portion of the side wall(s) comprise a flexible membrane, and at least a major portion of the side wall(s) and the substantially closed end are substantially impervious to water, wherein the apparatus forms at least a cod end portion of an apparatus for harvesting aquatic animals. The method may comprise the steps of: submerging the harvesting apparatus in a body of water and positioning and/or moving said harvesting apparatus such that there is water flow relative to the harvesting apparatus; capturing aquatic animals in the harvesting apparatus while providing a relaxed low flow rate environment for the aquatic animals in the apparatus; raising the harvesting apparatus while maintaining aquatic animals in a cod end portion of the apparatus, in a pool of water; then extracting the animals as described above in relation to the first aspect.

In a second aspect, the invention broadly consists in an apparatus for use with the method described above. The apparatus comprises a body having an open end and a substantially closed end and one or more side walls between the open end and the substantially closed end. At least a major portion of the side wall(s) comprise(s) a flexible membrane, and at least a major portion of the side wall(s) and the substantially closed end are substantially impervious to water. The apparatus further comprises a baffle defining a channel having a channel inlet and a channel outlet, the channel outlet being positioned more proximal the substantially closed end of the apparatus body than the channel inlet.

At least a major portion of the baffle may comprise a flexible membrane that is substantially impervious to water.

The baffle may be positioned in an interior of the apparatus body, or external to the apparatus body. The baffle may be attached to one or more of the wall(s) of the body for example, along two edges of the baffle.

In an embodiment, the baffle is movable between an inflated condition and a collapsed condition. In an embodiment, a cross-sectional area of the channel is greater in the inflated condition of the baffle than in the collapsed condition of the baffle. In the collapsed condition the baffle may be positioned against the respective body side wall(s). For example, a surface of the baffle may be flush with the respective body side wall(s).

In an embodiment, the baffle and/or the channel is tapered at an end of the baffle or channel proximal the channel outlet. The channel is preferably an elongate channel, and preferably extends along at least a major length of the apparatus body. However, the length of the channel may vary.

The apparatus may comprise a single baffle and channel or a plurality of baffles and/or channels. The or each channel may have a single outlet, or may have a plurality of outlets, for example, spaced lengthwise along the baffle.

In an embodiment, in the inflated condition, the baffle is concave relative to the respective body side wall(s), and in the collapsed condition, the baffle is convex relative to the respective body side wall(s). In an embodiment, the baffle comprises a plurality of apertures or permeable portions to assist movement of the baffle from the inflated condition to the collapsed condition.

The baffle and/or the channel may be tapered inwards at or towards the channel outlet. For example, such that the cross section of the channel is reduced by the taper compared to the cross section of the channel at a mid-point along the channel. A tapered portion proximal the channel outlet may be configured to increase back pressure in the channel to maintain the baffle in the inflated condition.

The channel inlet may be provided in an interior of the apparatus body, for example within the open end of the apparatus body. Alternatively, the channel inlet may be provided in a side of the apparatus, for example, through an opening in the apparatus body wall(s). The channel inlet is preferably configured to receive, or for coupling to, a pump outlet.

The apparatus may further comprise an elongate lengthener portion attached to the apparatus body. The lengthener portion has a leading end, a trailing end, and one or more side wall(s) between the leading end and the trailing end, wherein at least a major part of the side wall(s) comprise(s) a flexible membrane that is substantially impervious to water. The trailing end of the lengthener portion is operatively connected to the open end of the apparatus body. The elongate lengthener portion may have a plurality of escapements through which water can pass from an interior of the apparatus to an exterior of the apparatus to cause a general reduction in the water flow rate inside the apparatus from the leading end of the elongate lengthener portion toward the substantially closed end of the apparatus body when the apparatus is submerged in a body of water and there is water flow relative to the apparatus.

In some embodiments, the apparatus is an apparatus for harvesting aquatic animals, for example a trawl apparatus. Alternatively the apparatus may be an apparatus for transporting aquatic animals, for example.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both.

The invention consists in the foregoing and also envisages constructions of which the following gives examples only.

### BRIEF DESCRIPTION OF THE DRAWINGS

The present invention will now be described by way of example only and with reference to the accompanying drawings in which:

FIG. 1 is a rear overhead perspective view of an apparatus for harvesting aquatic animals;

FIG. 2 is a side view of the harvesting apparatus of FIG. 1;

FIG. 3 is the side view of FIG. 2 showing exemplary dimensions of the harvesting apparatus;

FIG. 4 is an exploded side view of the harvesting apparatus of FIGS. 1 to 3;

FIG. 5 is a partial perspective view showing the reinforcing on the entry cone and leading lengthener module in the harvesting apparatus of FIGS. 1 to 4;

FIG. 6 is a partial exploded view showing the connecting loops on the reinforcing on the entry cone and leading lengthener module of FIG. 5;

FIG. 7 is an enlarged partial perspective view showing the connection between the entry cone and leading lengthener module of FIGS. 6 and 5;

FIG. 8 shows a reinforced blank for forming the entry cone of the lengthener portion and for connecting to a lengthener module;

FIG. 9 is an enlargement of detail 9 in FIG. 8;

FIG. 10 is perspective view schematically showing various exemplary form escapements on a portion of an escapement module;

FIG. 11 is a partial perspective view showing a sinuous slit escapement open during use, as a result of the internal pressure in the harvesting apparatus;

FIG. 12 is a partial perspective view showing a straight slit escapement open during use, as a result of the internal pressure in the harvesting apparatus;

FIG. 13 is an overhead perspective view schematically showing the harvesting apparatus of FIGS. 1 to 3 attached to sweep wings, and being towed in a body of water behind a marine vessel;

FIG. 14 is a port side view of the harvesting apparatus of FIGS. 1 to 3 with streamlines to illustrate flow patterns in a vertical plane within and around the apparatus in use;

FIG. 15 is a top cutaway view of the harvesting apparatus of FIGS. 1 to 3 with the port half of the apparatus cut away and streamlines to illustrate flow patterns in a horizontal plane within the port half of the apparatus and around the apparatus in use;

FIG. 16 is a port side view of the harvesting apparatus of FIGS. 1 to 3 with contour lines to illustrate areas of different flow velocities within and around the apparatus in use;

FIG. 17 is a top cutaway view of the harvesting apparatus of FIGS. 1 to 3 with the port half of the apparatus cut away and contour lines to illustrate areas of different flow velocities within the port half of the harvesting apparatus and around the apparatus in use;

FIGS. 18(i) to 18(iv) are section views through the harvesting apparatus of FIGS. 1 to 3, with contour lines illustrating areas of different flow velocities within and around the apparatus in use; FIG. 18(i) is taken through line A-A of FIG. 3 through the first escapement module; FIG. 18(ii) is taken through line B-B of FIG. 3 through the extension module; FIG. 18(iii) is taken through line C-C of FIG. 3 through the second escapement module; and FIG. 18(iv) is taken through line D-D of FIG. 3 through the cod end portion;

FIG. 19 is a graph showing flow velocity and internal pressure along the central longitudinal axis for the harvesting apparatus shown in FIGS. 1 to 18(iv), towed through the water at 3 knots (1.544 ms⁻¹) from a point 2m in front of the entry mouth of the apparatus;

FIG. 20 is a graph showing internal flow velocity across the diameter of the harvesting apparatus shown in FIGS. 1 to 18(iv) towed through the water at 3 knots (1.544 ms⁻¹) at various points along the apparatus; the line shown with solid triangles is taken through plane A-A shown in FIG. 3, along a vertical transect; the line with solid circles is taken through plane C-C shown in FIG. 3, along a horizontal transect; the line with hollow circles is taken through plane C-C shown in FIG. 3, along a vertical transect; and the line with hollow triangles is taken through plane D-D shown in FIG. 3;

FIG. 21 is a rear overhead perspective view of a harvesting apparatus in accordance with a second embodiment apparatus for harvesting aquatic animals;

FIG. 22 is a port side view of the harvesting apparatus of FIG. 21 with streamlines to illustrate flow patterns in a vertical plane within and around the apparatus in use;

FIG. 23 is a top cutaway view of the apparatus of FIG. 21 with the port half of the apparatus cut away and streamlines to illustrate flow patterns in a horizontal plane within the port half of the apparatus and around the apparatus in use;

FIG. 24 is a side schematic view of an apparatus for use with methods of the present invention;

FIG. 25 is wireframe perspective view of the apparatus of FIG. 24, showing flow velocities in the apparatus during an exemplary process of extracting aquatic animals from the apparatus;

FIG. 26 is a perspective view showing the arrangement of the apparatus of FIGS. 24 and 25 on the stern of a marine vessel during a process of extracting aquatic animals from the apparatus;

FIG. 27 is a front view corresponding to FIG. 26;

FIG. 28 is a perspective view showing the arrangement of an alternative embodiment apparatus on the stern of a marine vessel during a process of extracting aquatic animals from the apparatus;

FIG. 29 is a front view corresponding to FIG. 28;

FIG. 30 is a front perspective view of the apparatus of FIGS. 24 and 25 positioned on the stern of a marine vessel attached to a pump by way of a flexible coupling, and showing an onboard grading system;

FIG. 31 is a rear view of the arrangement in FIG. 30;

FIG. 32 is an isometric view of the flexible coupling used in the arrangement of FIGS. 30 and 31, for attaching the apparatus of FIGS. 24 and 25 to the pump outlet;

FIG. 33 is an end view corresponding to FIG. 32;

FIG. 34 is a section view of the apparatus of FIGS. 24 to 35, showing flow characteristics during the exemplary process of extracting aquatic animals from the apparatus;

FIG. 35 is a wireframe perspective view corresponding to FIG. 34;

FIG. 36 is a rear perspective view showing a step of a method of emptying at least some of the remainder of harvested catch following the method of removing the majority of the animals using liquid flow; and

FIG. 37 is a rear perspective view showing a subsequent step of the method of emptying at least some of the remainder of harvested catch.

### DETAILED DESCRIPTION OF A PREFERRED EMBODIMENT

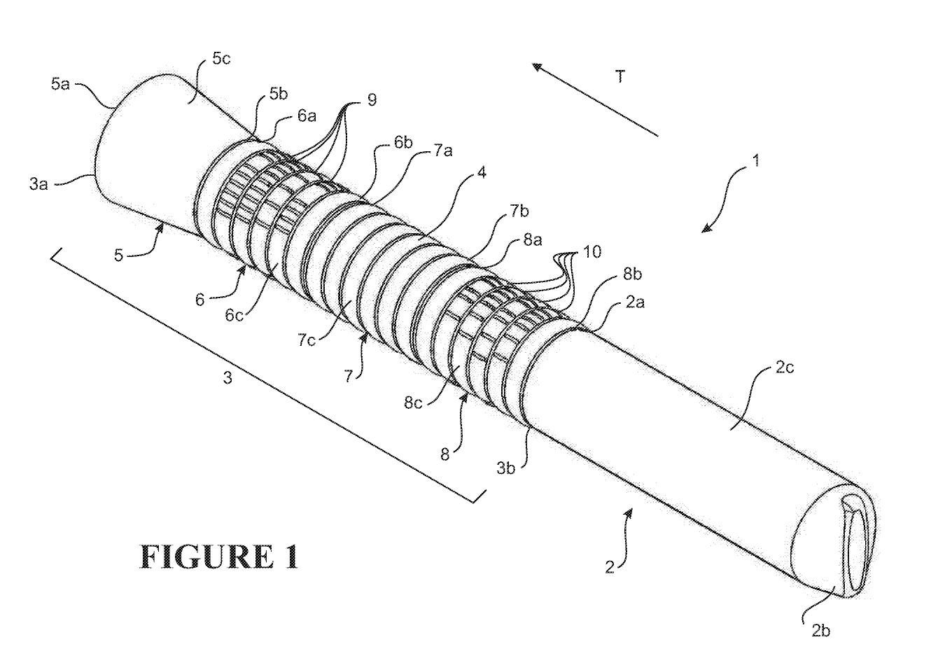

Embodiments of the present invention relate to a method for extracting aquatic animals from and aquatic animal harvesting or transporting apparatus. For example, from a harvesting apparatus such as that disclosed in PCT application PCT/IB2013/055858 (WO 2014/140702), which is incorporated herein by reference. For completeness, FIGS. 1 to 23 and the description below describe the aquatic animal harvesting apparatus disclosed in that document.

### Aquatic Animal Harvesting Apparatus

FIGS. 1 to 7 illustrate an apparatus 1 for harvesting aquatic animals. In the embodiment shown, the apparatus 1 is configured as a trawling apparatus for pelagic or bottom trawling, for capturing aquatic animals such as finfish such as hoki, alfonsino, snapper, trevally, gurnard, barracouta, or flatfish, molluscs such as squid, and/or crustaceans such as crabs for example. FIGS. 1 to 7 show the apparatus in an expanded configuration, in use. In a preferred form, the apparatus 1 replaces the mesh cod end on a traditional trawling net.

The apparatus is a modular bag 1 comprising a trailing cod end portion 2, having an open leading end 2a, a closed trailing end 2b, and one or more side walls 2c extending between the leading end and the trailing end. The apparatus further comprises an elongate lengthener portion 3, having an open trailing end 3b operatively connected to the open leading end 2a of the cod end portion 2, and an open leading end 3a that forms an open mouth of the apparatus.

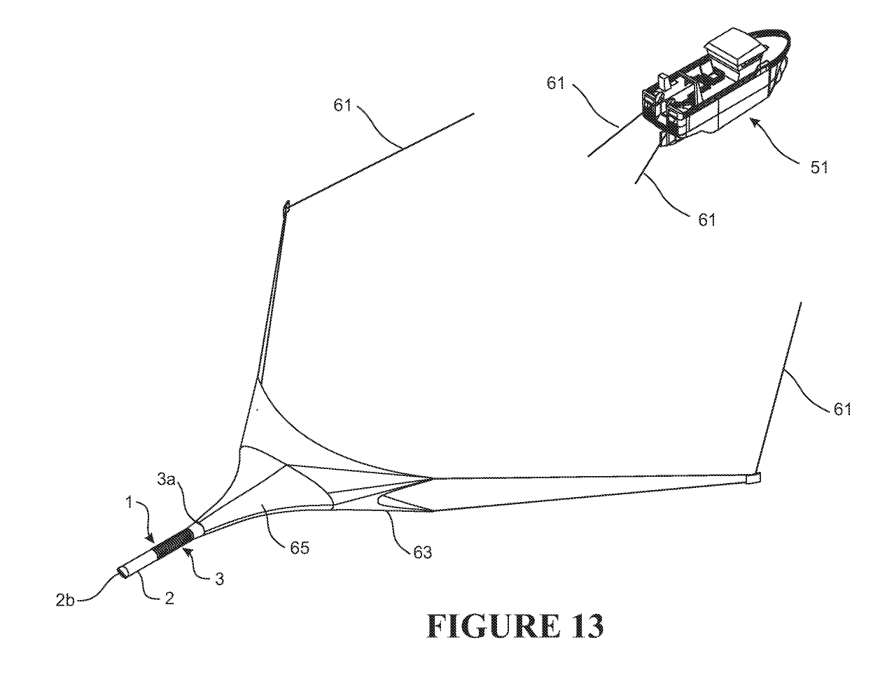

The leading end 3a of the lengthener portion 3 is operatively connected to diverging sweep wings 63 and/or to the bosom 65 of the net as shown in FIG. 13, to direct aquatic animals into the apparatus 1. The sweep wings 63 are in turn operatively connected to a towing marine vessel 51 such as a boat by way of cables 61 or the like. The apparatus 1 is configured to be towed in a towing direction T through the body of water by the towing vessel 51. The sweep wings 63 and cables 61 can be a conventional design. The apparatus 1 can be provided as an entire trawling apparatus including sweep wings and cables, or alternatively could be retrofitted to an existing trawling net, by operatively connecting the apparatus to sweep wings or a bosom of the existing trawling net. Adapter sections could be used, if necessary, to adapt the apparatus to trawl nets used for different purposes, such as mid-water or bottom trawling for example.

The elongate lengthener portion 3 comprises an entry cone 5 and three lengthener modules 6, 7, 8 connected in series. The entry cone 5 is positioned at the leading end 3a of the lengthener portion. The entry cone comprises an open leading end 5a that forms the open mouth of the apparatus, and a trailing end 5b connected to the leading end 6a of the first lengthener module 6. The wall(s) 5c of the entry cone 5 tapers from the leading end 5a to the trailing end 5b, to direct water and animals into the lengthener modules 6, 7, 8 as the apparatus 1 is towed through the water. The cod end 2, entry cone 5, and lengthener modules 6, 7, 8 are configured to be coaxial when the apparatus 1 is expanded.

Each lengthener module 6, 7, 8 has an open leading end 6a, 7a, 8a, an open trailing end 6b, 7b, 8b, and one or more walls 6c, 7c, 8c extending between the respective leading and trailing ends. The leading end 6a of the first lengthener module 6 is operatively connected to the trailing end 5b of the entry cone 5. The leading end 7a of the second lengthener module 7 is operatively connected to the trailing end 6b of the first lengthener module 6. Similarly, the leading end 8a of the third lengthener module 8 is operatively connected to the trailing end 7b of the second lengthener module 7, and the trailing end 8b is operatively connected to the leading end 2a of the cod end portion 2.

The side wall 2c and the trailing end 2b of the cod end portion 2 are substantially impervious to water and preferably are totally impervious to water. At least a major part (i.e., a majority) of the side walls 5c, 6c, 7c, 8c of the entry cone and lengthener modules are also substantially impervious to water. In a preferred embodiment, the seal at the trailing end 2b of the cod end portion 2 is achieved through rolling cod end portion wall(s) 2c, then lacing reinforcing members on the outer surface of the walls 2 with a chain stitch.

The walls 2c, 3c, 5c, 6c, 7c, 8c of the cod end, entry cone, and lengthener portions are also flexible, such that the apparatus 1 is collapsible and expandable between a collapsed configuration and an inflated or expanded configuration. The empty apparatus is likely, for example, to be stored on a boat in the collapsed state. When the apparatus is towed in a body of water, such that the flow of water is substantially parallel to the longitudinal axis of the apparatus, internal water pressure causes the apparatus to self-inflate.

The side wall portions or side walls 2c, 6c, 7c, 8c of the lengthener modules 6, 7, 8 and cod end 2 are substantially parallel when the apparatus is expanded. Portions of the walls may bow or bulge outwards under the internal pressure in the apparatus 1, as shown, i.e. such that portions of the walls are inwardly concave. The cod end 2 and elongate lengthener portion 3 are substantially cylindrical (aside from the entry cone) when the apparatus is expanded. In alternative embodiments, rather than having a circular cross section, the cod end 2 and/or the lengthener portion 3 may have a different cross-sectional configuration when the apparatus is expanded, such as an elliptical or polygonal configuration. By way of example, the lengthener portion may have a substantially square, rectangular, hexagonal, or octagonal cross-sectional configuration when the apparatus is expanded.

The trailing end 2b of the cod end portion may be at least partially internally concave when the apparatus is expanded, as shown in FIG. 1.

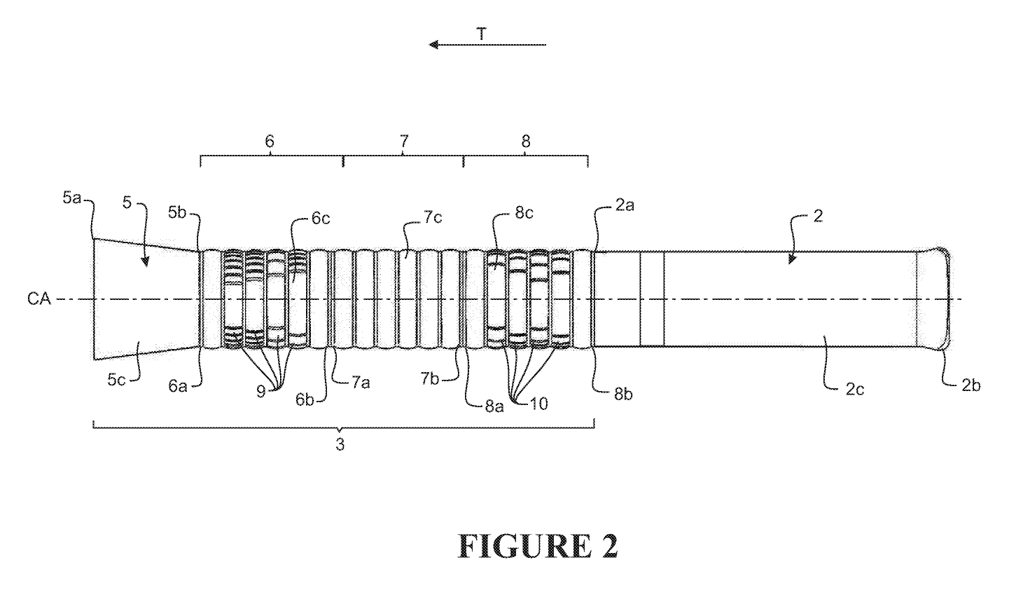

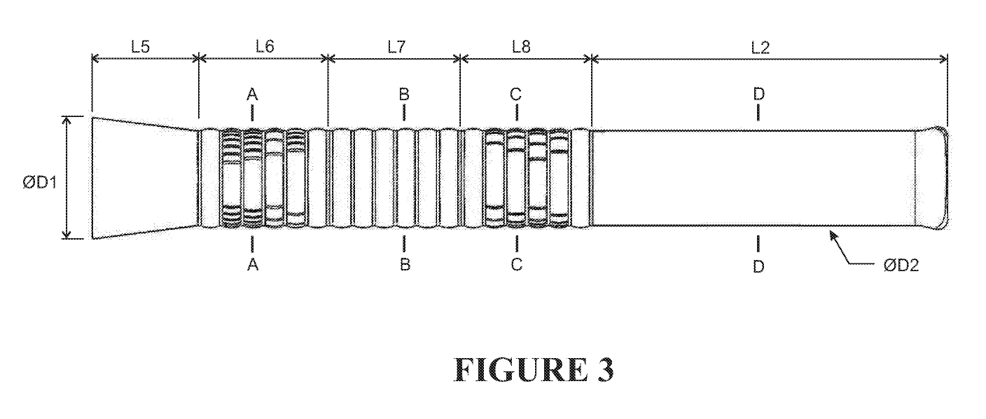

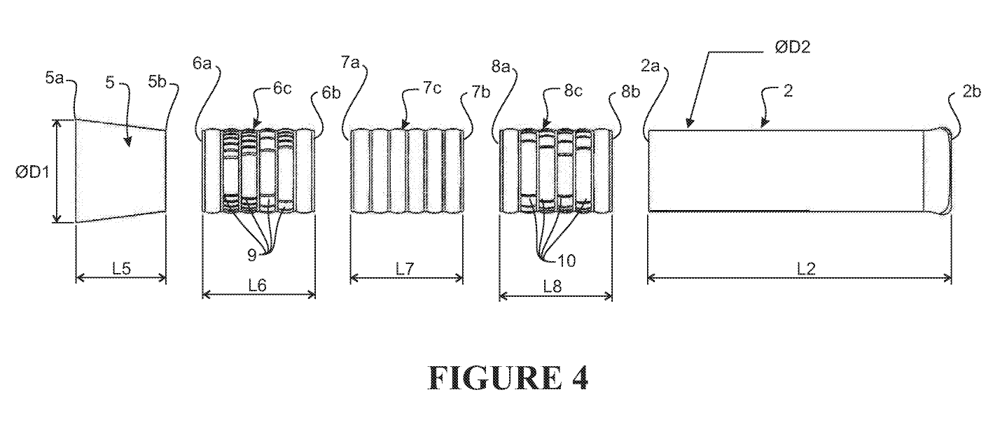

The entry cone 5, lengthener modules 6, 7, 8, and the cod end 2 are preferably separable. This enables the apparatus to be customised by substituting, adding, or removing various lengthener modules to suit a particular application. FIGS. 3 and 4 show exemplary dimensions of the various sections 5, 6, 7, 8, and 2 of the apparatus 1. FIG. 4 is an exploded view of the apparatus in FIGS. 1 to 2 showing the various sections 5, 6, 7, 8, 2 of the apparatus 1 separated. In one embodiment, the three lengthener modules 6, 7, 8 are dimensionally equivalent and each have a length L6, L7, L8 of about 2040 mm. The cod end 2, the lengthener modules 6, 7, 8, and the trailing end 5b of the entry cone have a diameter D2 of about 1460 mm. In the embodiment shown, the entry cone has a length L5 of 1637 mm and the diameter D1 of its leading end 5a, forming the mouth of the apparatus, is about 1870 mm. These dimensions are exemplary and may be modified depending on the use of the apparatus 1, or to increase capacity, for example. In an exemplary embodiment, the maximum diameter of the lengthener portion 3 and cod end 2 is limited by the width of the decks on the towing vessel and/or onboard equipment such as rollers or drums for handling of the apparatus 1.

In the embodiment shown, the leading and trailing lengthener modules 6, 8 are escapement modules comprising a plurality of openings 9, 10 in the respective module walls 6c, 8c. These openings 9, 10 form escapements 9, 10 through which water can pass from an interior of the apparatus 1 to an exterior of the apparatus, to cause a reduction in the water flow rate inside the apparatus from the leading end 3a of the elongate lengthener portion toward the trailing end of the cod end portion 2b when the apparatus 1 is towed in direction T through a body of water.

In the embodiment shown, the second lengthener module 7 is an extension module. The wall 7c of extension module 7 does not contain any escapements, so the flow rate into the leading end 7a of the extension module 7 will be substantially the same as the flow rate out of the trailing end 7b extension module 7 as the apparatus is towed through the water in direction T.

The substantial impermeablity of the walls 2c, 6c, 7c, 8c of the cod end portion 2 and lengthener modules to water is such that the ability of water to flow out through the cod end is much less than the ability of water to flow out the escapement module(s) 6, 8, and such that the ability of water to flow out through the walls 6c, 8c of the escapement portions is much less than the ability of water to flow out through the escapements 9, 10.

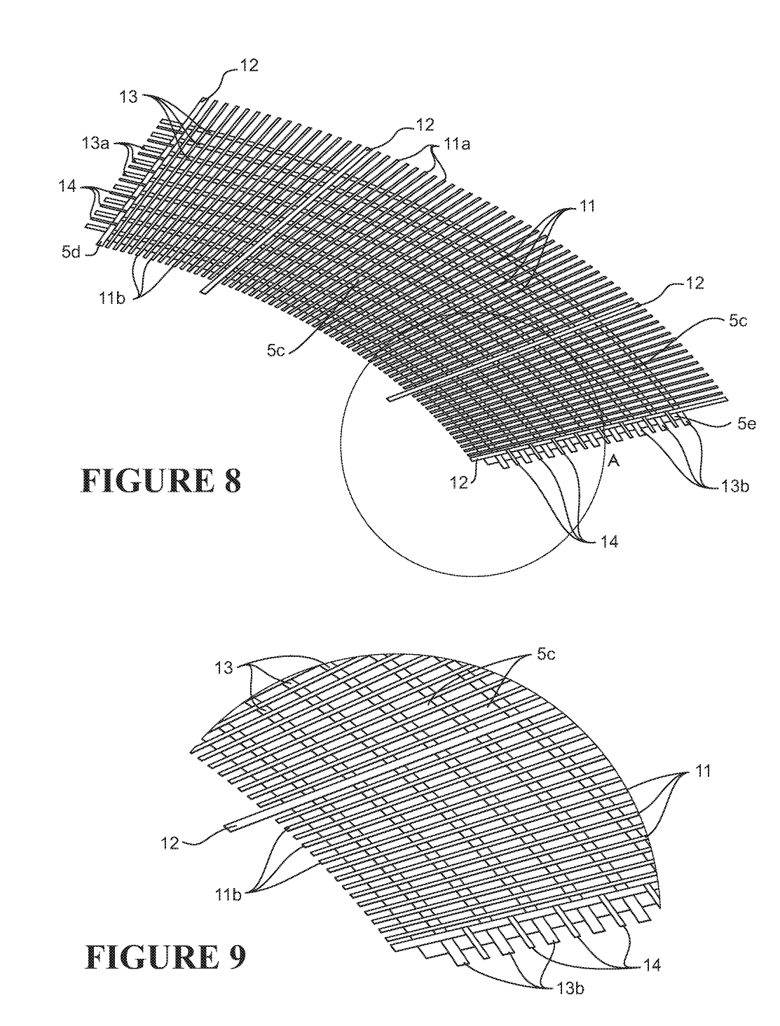

In one embodiment, the side walls 2c, 3c, 5c, 6c, 7c of the cod end, entry cone and lengthener modules comprise a flexible membrane 4. Preferably the side walls 2c, 3c, 5c, 6c, 7c comprise an impervious material such as PVC or ripstop PVC, sail-making fabric, woven nylon airbag fabric, polyester, or polyethylene. In some embodiments, woven custom modules may be used. In a preferred embodiment, each lengthener module and the cod end portion 2 is constructed from a rectangular blank by joining two opposite edges of the blank. The edges may be joined by stitching, a zipper, tying sides together, or any other suitable fastening means. The entry cone is similarly constructed, but from a blank that forms a frustoconical shape when assembled. A blank for forming the entry cone 5 is shown in FIG. 8, and in the detail view of FIG. 9.

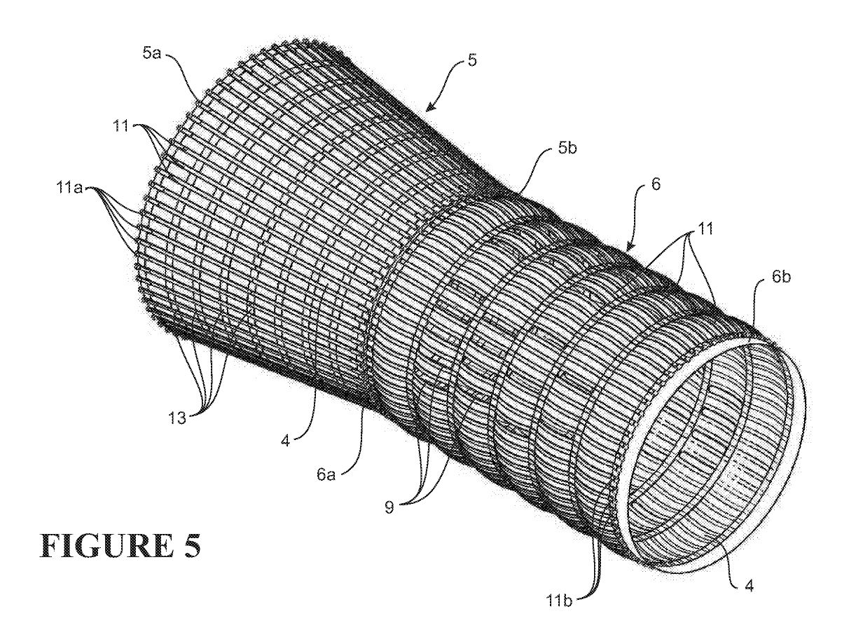

The entry cone 5, lengthener modules 6, 7, 8, and the cod end 2 comprise longitudinal and circumferential reinforcing components to strengthen the apparatus. FIGS. 5 to 7 show reinforcing in the form of reinforcing strips 11, 13 on the entry cone 5 and the first lengthener module 6. In that embodiment, the entry cone 5 comprises nine circumferential reinforcing strips 13 and a plurality of longitudinal reinforcing strips 11. The first lengthener module 6 comprises seven circumferential reinforcing strips 13 and a plurality of longitudinal reinforcing strips 11. The second and third lengthener modules 7, 8 and the cod end 2 are reinforced in a similar manner. The circumferential reinforcing strips 13 take the hoop stress of the inflated apparatus 1 as it is towed, and the longitudinal reinforcing strips 11 take up the tensile stress. The apparatus may additionally comprise a plurality of higher strength longitudinal strips as hauling strips (not shown). An exemplary embodiment comprises 3-4 hauling strips 12 rated to 6 tonnes each, arranged along the length of the lengthener portion 3 and cod end portion 2. These strips provide conventional hauling points for towing and handling the apparatus 1.

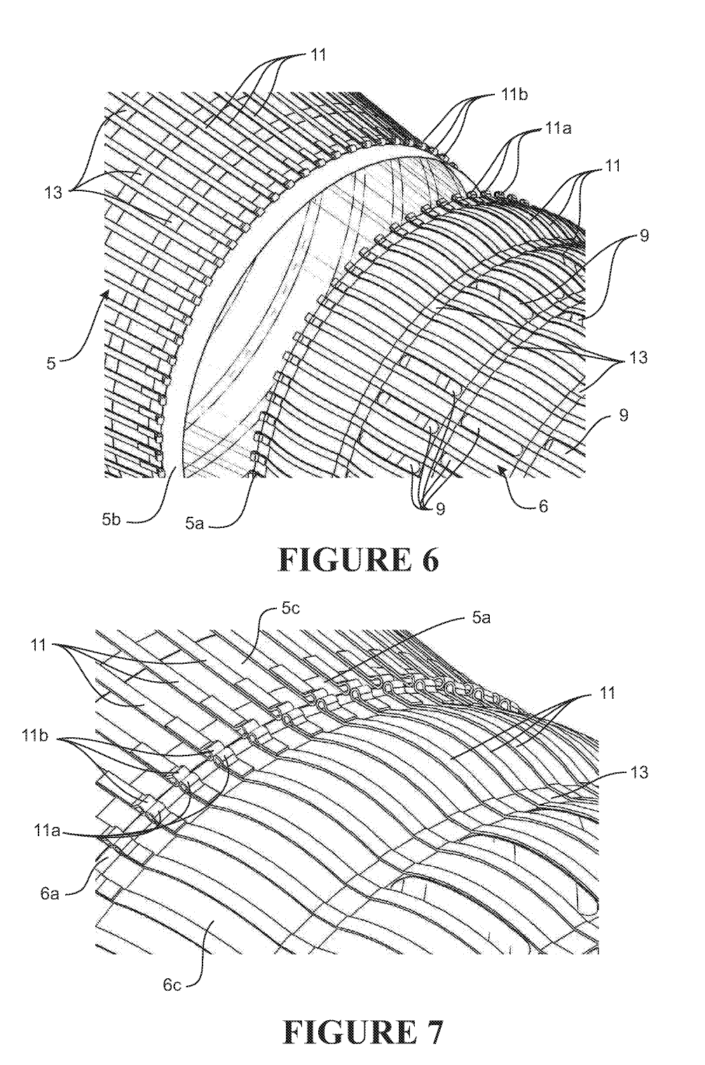

FIGS. 8 and 9 illustrate a blank for forming the entry cone module 5. The membrane wall 5c is reinforced on its external surface by transverse/circumferential reinforcing strips 13 and longitudinal reinforcing and haul strips 11, 12. The ends of the longitudinal strips 11b may be looped over to form loops for attaching an adjacent lengthener module as shown in FIGS. 6 and 7. The ends 13a, 13b of the transverse reinforcing strips 13a, 13b may similarly be looped over to form loops for stitching the two opposed side edges 5d, 5e together to form the entry cone 5. Additional loop members 14 may be provided for improving the stitched connection between the two sides 5d, 5e.

The cod end portion 2 is preferably reinforced to a greater extent than the lengthener portion 3 to accommodate the additional loading in the cod end portion as the apparatus is towed and retrieved. In an exemplary preferred embodiment, circumferential reinforcing strips 11 are spaced at 325 mm points along the length of the lengthener portion 3, and at 200 mm points along the cod end portion 2. The cod end portion 2 may preferably also comprise diagonal reinforcement members arranged on the external surface of the apparatus at an angle to both the circumferential and longitudinal strips 11, 13. Diagonal reinforcing around the cod end portion 2 helps to spread the load of lifting from the rear as described below, or while being hauled from the front of the cod end 2 itself.

In an exemplary embodiment, the reinforcing strips comprise 50 mm polyester seat belt webbing. Alternatively, the reinforcing strips may comprise other nylon and/or polyester webbing, PVC, Dynex, or Kevlar, or any flexible, strong and abrasion resistant material that can be formed into strips and attached via sewing or welding to the membrane. The reinforcing strips may be any suitable width.

The reinforcing strips 11, 13 are flexible and attached to the external surface of the membrane walls 4. Having the reinforcing positioned on the external surface of the membrane walls minimises contact of aquatic animals with the reinforcing, maintaining the smoothness of the internal surface and minimising abrasive damage to the captured animals. External reinforcing strips also protects the membrane wall 5c, 6c, 7c, 8c, 2c from abrasion against the sea floor during bottom trawling, and/or against the edge and deck of the towing vessel as it is hauled on board.

In an exemplary embodiment, the reinforcing strips 11, 13 are stitched to the walls 5c, 6c, 7c, 8c, 2c of the apparatus. Depending of the material of the reinforcing strips 11, 13, the strips could be otherwise attached. For example, PVC reinforcing strips may be welded or glued to the external wall surfaces 5c, 6c, 7c, 8c, 2c.

Each end of each longitudinal strip 11 on the entry cone 5 and on the lengthener modules 6, 7, 8 comprises a loop portion 11a, 11b. The ends of the longitudinal strips at the leading end of the cod portion 2 also comprise loop portions. When the apparatus is assembled, the various sections 5, 6, 7, 8, 2 are arranged so that longitudinal reinforcing strips 11 on adjacent modules line up. Adjacent sections or modules are then connected by stitching the modules together with a chain stitch through the loops 11a, 11b. In alternative embodiments, adjacent sections may be connected using other fastening means such as zips, clips, adhesives, or different types of stitching. The type of fastening will depend on the end use and capacity of the apparatus. For example chain stitching generally provides a stronger connection than a zipper and would therefore be suitable for higher capacity applications.

The escapement modules 6, 8 each comprise a plurality of escapements 9, 10. The escapements 9, 10 comprise apertures that are sized, shaped and positioned to exploit anthropometric and behavioural characteristics of various aquatic animals to improve the selectivity of the apparatus 1. The escapements 9, 10 exploit such characteristics by way of their size, appearance to the animals, and by the flow rates and flow patterns they generate as the apparatus 1 is towed through the water.

Each escapement 9, 10 allows the passage of aquatic animals smaller than the aperture to exit from the interior of the apparatus to the exterior of the apparatus, through the escapement 9, 10. The escapements are preferably sized to allow the passage of young or undersized aquatic animals, or unwanted species, but prevent the passage of animals of a commercially usefully size.

Traditional netting strands are abrasive and often cause damage to escaping animals, for example by rubbing off scales. In addition, the abrasive and rigid nature of the tensioned strands in a traditional net means that animals are often not able to free themselves once they are caught, without suffering substantial damage. In contrast, the flexible and smooth impermeable membrane walls 4 in preferred embodiments of the present apparatus minimises abrasive damage to animals contacting the edges of the escapements 9, 10 as they exit the apparatus 1, and allow animals caught at the escapement to free themselves. For example, irregularly shaped animals such as gurnard that are close to an aperture size are able to waffle through the flexible escapements to free themselves with no or only minimal damage.

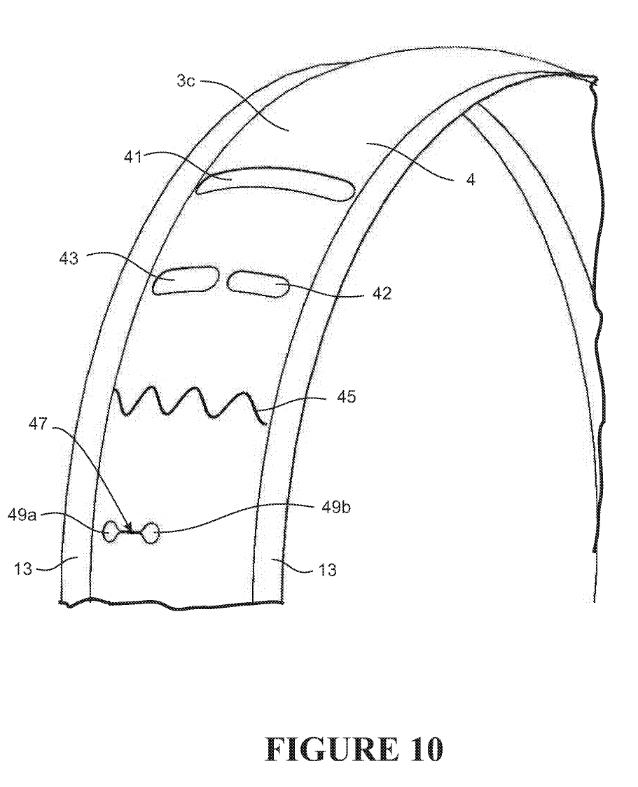

The escapements 9, 10 may comprise slits, slots, or other openings and may comprise straight and/or curved portions. FIG. 10 shows several possible exemplary escapements 41, 42, 43, 45, 47. The escapements 9, 41, 42, 43, 45, 47 are formed by cutting slits, slots, or other openings in a wall 3c, 6c, 8c of an escapement module 6, 8. Any one or more escapement modules may comprise a plurality of escapements of different sizes and/or different type. Alternatively any one or more escapement modules may comprise a plurality of identical escapements. Because the walls comprise a flexible membrane, the modules are very easy to customise and escapements can be easily shaped, sized and positioned as desired.

Escapements 41, 42, and 43 shown in FIG. 10 are examples of slot-type escapements. Escapement 45 is an exemplary sinuous slit-type escapement, and escapement 47 is a straight slit-type escapement.

When the escapements are formed by slits 45, 47 in the walls 3c, 6c, 8c of the escapement modules, the slits may comprise anti-tear apertures 49a, 49b at the ends of the slits. Alternatively, the ends of the slits may be otherwise reinforced, for example by stitching. In some embodiments, reinforcing may not be necessary, for example where the walls comprise a rip-stop material, or where the ends of the slits 45 coincide with the circumferential or longitudinal reinforcing strips 11, 13.

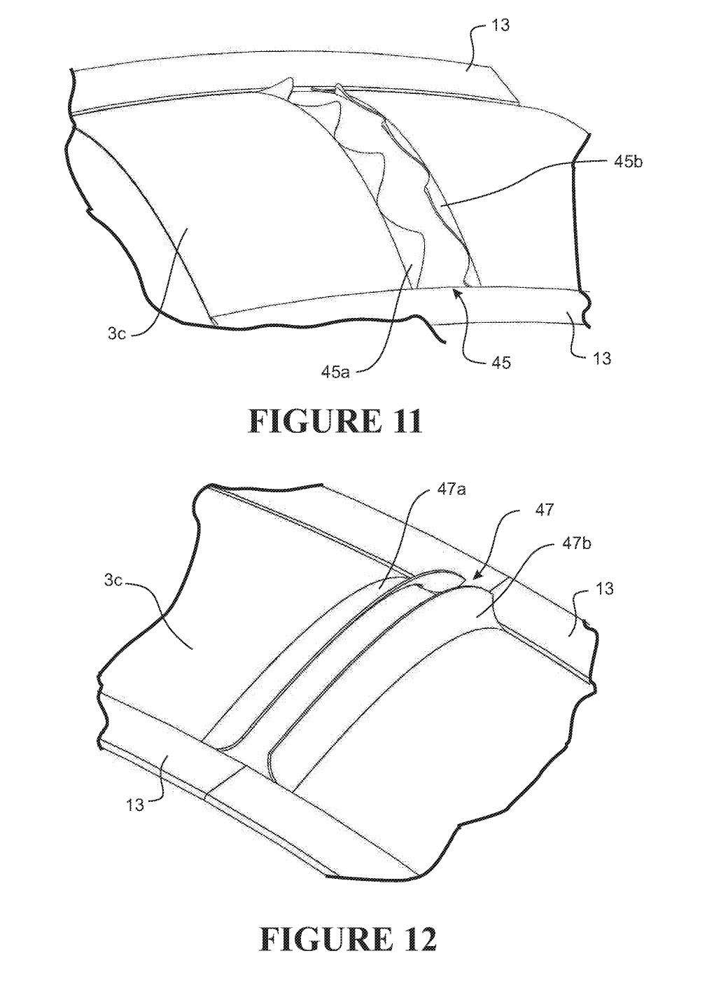

Slits transform to form escapement ‘slots’ when the apparatus is inflated, as shown in FIGS. 11 and 12. The walls 45a, 45b, 47a, 47b on either side of a slit 45, 47 form flaps or ‘fingers’ that open under the internal pressure in the apparatus. The width of the ‘slot’ is determined by the amplitude of the curve or of the ‘fingers’ or ‘flaps’. The degree to which the flaps open is a function of the internal pressure in the apparatus, which in turn is a function of the tow speed. Therefore slit-type escapements 45, 47 are reactive to the water flow and are more open at higher tow speeds. The escapement appears to disappear when the flow rate and pressure drop and the flaps 45a, 45b, 47a, 47b close.

Curved slots 47 open more readily than straight slots 45 in use when the walls are bowing or bulging out under the internal pressure in the apparatus. Slits with a low degree of curvature or smaller cord length are more ‘rigid’ and don't open as much under higher pressures. The shape of the slits, for example the amplitude of a sinuous slit, may be selected to increase the sensitivity of the escapement ‘openness’ to tow speed. This variable opening may be beneficial in inflating the apparatus, especially at low tow speeds. Escapements that close at low tow speeds also are advantageous during retrieval of the apparatus at the end of a tow, when the apertures close to provide a physical and visual barrier to prevent captured animals escaping.

The escapements 9 are positioned in discrete regions in the side walls 6c, 8c of the respective modules 6, 8. In the embodiment shown in FIGS. 1 to 3, the escapements 9, 10 are provided in a top region and in a lower region of the escapement modules 6, 8, and the sides are free of escapements.

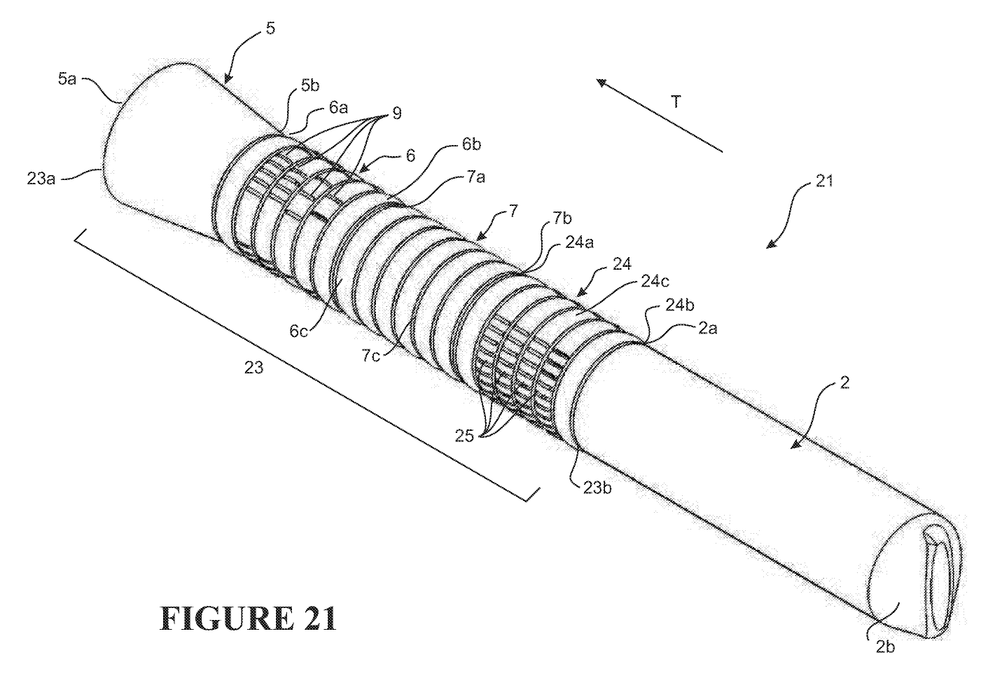

FIG. 21 illustrates an apparatus 21 for harvesting aquatic animals in accordance with a second exemplary embodiment. The apparatus 21 is configured with an elongate lengthener portion 23 comprising an entry cone 5 and three lengthener modules 6, 7, 24 connected in series; and a cod end portion 2. The open trailing end 23b of the lengthener portion is operatively connected to the open leading end 2a of the cod end portion 2, and the open leading end 3a of the lengthener portion 23 forms an open mouth of the apparatus.

The cod end portion 2, entry cone 5, first lengthener portion 6, and extension module 7 in the embodiment of FIG. 21 are as described above in relation to the first embodiment shown in FIGS. 1 to 4. In the embodiment of FIG. 21, the second escapement module 24 has been substituted for the second escapement module 8.

The second escapement module 24 comprises an open leading end 24a operatively connected to the trailing end of the extension module 7, and an open trailing end 24b that forms the trailing end of the lengthener portion 23b and is operably connected to the leading end of the cod end portion 2. The escapement module 24 further comprises a plurality of openings 25, which form escapements through which water can pass from an interior of the apparatus 21 to an exterior of the apparatus 21 to cause a reduction in the water flow rate inside the apparatus from the leading end 24a of the second escapement portion toward the trailing end of the second escapement portion 23b when the apparatus 21 is towed in direction T through a body of water.

The side wall(s) 24c of the second escapement module 23 comprise a flexible membrane that is substantially impervious to water. The escapements 25 are provided in port and starboard regions of the membrane 23c, rather than in upper and lower regions of the module as in the second escapement module 8 in FIGS. 1 to 4.

The escapements 9, 10, 24 may be positioned to exploit behavioural characteristics of fish to aid in selection. This may be achieved placing the escapements in areas that unwanted species are likely to be more attracted to, and/or by creating desired flow patterns in the apparatus to encourage different species towards or away from the escapements 9, 10, 24.

By way of example, in the embodiment of FIGS. 1 to 7, the escapements 9, 10 are positioned in upper and lower regions of the escapement modules 6, 8. The side regions of the escapement modules are substantially impermeable. In this example, pelagic species such as barracouta, dogfish and hoki will want to swim upwards and will escape thought the escapements 9, 10, but surface aversive species such as snapper, groper, trevally and alfonsino will swim away from the escapements 9, 10 and be captured. Benthic fish such as gurnard and flatfish may prefer to escape through the lower escapements 9, 10; however, surface preferring fish may also be gently recirculated by the flow in the apparatus 1 into the proximity of the upper escapements and escape through the upper escapements. The lower escapements also provide lift for the apparatus to prevent the apparatus dragging on the seabed when bottom trawling.

In the embodiment of FIG. 21, the escapements 9 in the first escapement module 6 are positioned in upper and lower regions, and the escapements 25 in the second escapement module 24 are symmetrically positioned in side regions. Such a configuration could be used could be used to increase the retention of pelagic, surface-seeking fish such as barracouta, as there are no escapements in the upper region of the apparatus where they are likely to swim.

Alternatively, the escapements may be positioned in different regions or walls of the escapement modules, depending on the desired application. Alternatively, one or more escapement modules may comprise escapements evenly positioned around the module.

The appearance of the escapements may also be modified to make the escapements more or less attractive to different species. For example in escapements 45, 47 formed by slits, the sides of the slits form ‘flaps’ 45a, 45b, 47a, 47b that fold outwards under internal pressure in the apparatus 1 and the loose edges of the flaps give apparent depth to the escapements and make the escapements appear smaller than their actual size. The flaps also move as the apparatus is towed. This apparent depth and the moving flaps deter many species. The apparent ‘depth’ of the escapements may therefore be altered by changing the size of the flaps. The smaller appearance of the escapements provides the advantage of deterring animals that may not easily pass through the escapement, and the flaps 45a, 45b, 47a, 47b are able to yield to allow fish larger than the apparent escapement through.

An alternative exemplary embodiment comprises elongate, longitudinal ‘spaghetti’ escapements in the first escapement module 6. These long escapements are avoided by surface aversive fish such as hapuka but appear open to sharks. Long escapements can also provide low damage ‘overflow’ zones in case of over filling of the apparatus 1 with animals.

The escapement regions may also be coloured to attract or detract certain fish species. For example, the impervious or closely woven construction of the module membranes of the preferred form apparatuses allows light intensity and colour to be used to further improve selection. The membranes may be opaque, multi-coloured, or transparent/translucent. Species such as barracouta are strongly attracted to transparent and translucent zones allowing them to be directed toward or away from escapements or towards specific zones within the preferred form apparatuses.

The number of escapements will be a function of the size and shape of the escapements in each escapement lengthener module 6, 8, and the size of the swept intake area on the entry cone 5, D1. Preferably the total, open area of the escapements when the bag is fully inflated is less than about 60% of the intake area of the leading end 5a of the entry cone 5, and more preferably is about 55 to about 60%. An escapement area that is too high compared to the swept entry cone area will provide difficulties inflating the apparatus. An escapement area that is too low will result in a large bow wave in front of the cone which will force animals through any attached netting. An open escapement area between about 55% and about 60% of the swept entry cone area generally ensures reliable inflation of the structure, minimal bow wave in front of the cone and good transport of the animals into the low velocity and escapement areas 9, 10.

The wall angle of the entry cone 2 may be selected depending on the intended trawl speed, surface to volume ratio of the apparatus 1, the number and type of escapements 9, 10, and to be compatible with onboard equipment. For example, slit type escapements that open under pressure will dynamically change their apertures depending on the tow speed. If the escapement ratio to swept area is designed for a specific towing velocity range, the escapements will open under pressure to the appropriate size. At low tow speeds the constricted aperture will provide some resistance to flow and assist inflation of the apparatus. The total open area of the escapements 9, 10 when the apparatus is inflated in use is much smaller than the open area of traditional trawl nets. For example, in a traditional net, the open area or porosity of the net may be between about 50% and 70%. In the apparatus shown in FIGS. 1 to 7, the total area of the escapements is only about 3% of the total wall area of the lengthener portion 3.

Large areas of small escapements may require compensation for added resistance.

To assemble the apparatus shown in the Figures, the entry cone 5, lengthener modules 6, 7, 8, and the cod end portion 2 are provided as separate blanks. Each blank is individually assembled as described above—by connecting opposing sides along a longitudinal seam, and in the case of the cod end portion, sealing the trailing end 2b. The modules 6, 7, 8 are then arranged in series between the entry cone 5 and the cod end portion 2. The modules 6, 7, 8 may be arranged in any desired order. In alternative embodiments, additional escapement modules or lengthener modules may be added, or substituted for the modules shown such that the apparatus may be configured to suit the desired application, such as to achieve desired selectivity of species capture, or greater capture capacity, for example. In alternative embodiments, fewer escapement modules may be provided.

Adjacent sections 5, 6, 7, 8, 2 are then connected using any suitable fastening means, preferably by stitching the reinforcing strips in adjacent modules together, for example using a chain stitch. After the apparatus has been assembled, the apparatus may be readily modified to customise it for a different application or fishery, by disassembling one or more of the inter-section connections and adding and/or removing modules as required. The modular nature of the device enables easy tailoring of the device for different applications.

The apparatus may be sized to provide a much larger volume within the apparatus than conventional mesh cod ends, which further reduces animal to animal, animal to surface, and animal to debris contact.

The apparatus described above is an exemplary apparatus only and a number of modifications are possible. For example, the apparatus 1 has been described as having a lengthener portion 3 with three lengthener modules 6, 7, 8 and an entrance cone 5. Alternatively the lengthener portion 3 may not comprise an entry cone and/or may comprise a single lengthener or any other number of lengthener modules connected in series. The apparatus is described as having two spaced apart escapement modules 6, 8. Alternatively the apparatus 1 may comprise only a single escapement module with one or a plurality of escapement regions, or the apparatus may comprise three, four, or any other number of escapement modules. The escapement modules may be adjacent each other or separated by blank extension modules.

In one embodiment, the cod-end portion 2 and the lengthener portion 3 could be integral.

A system having a plurality of lengthener modules 6, 7, 8 is customisable for different applications by rearranging, substituting, removing and/or adding various lengthener modules. Preferably the internal transverse dimensions of the lengthener modules 6, 7, 8 are all equivalent to facilitate this interchangeability. Preferably the modules are also the same length. However, alternatively the modules may have different lengths and/or different internal dimensions. For example, one or more lengthener modules may be tapered so that its leading end has a greater internal transverse dimension than its trailing end.

The cod end 2 and elongate lengthener portion 3 are described as being substantially cylindrical when the apparatus is expanded. In alternative embodiments, the cod end 2 and/or the lengthener portion 3 may have a different cross-sectional configuration when the apparatus is expanded, such as an elliptical or polygonal configuration. By way of example, the lengthener portion may have a substantially square, rectangular, hexagonal, or octagonal cross-sectional configuration when the apparatus is expanded.

As another example, the apparatus could be provided with internal bracing to assist with forming the desired inflated shape of the apparatus.

The embodiments described above are designed to retain species larger than a given size and eject undersized fish. Alternative embodiments may be configured to capture juveniles of desired species. One such embodiment may have smaller escapements in the escapement module 8 nearest the cod end portion 2, and may comprise more or longer extension modules 6 to space the juvenile fish in the cod end portion 2 further from any larger escapements and/or high velocity flows in anterior escapement modules. The towing velocity of the apparatus may also be reduced to enable adult or larger animals to swim forward from the cod end portion and out through the anterior escapements.

Use of the Apparatus

FIG. 13 schematically shows the apparatus 1 towed behind a marine vessel 51. Apparatus 21 would be towed in a similar manner. The leading end 3a of the apparatus 1 is operatively connected to sweep wings 63, and the sweep wings are connected to a towing vessel 51 such as a boat by cables 61. In a first step, the apparatus 1 is allowed to roll off the back of the boat 51, and is submerged in a body of water, for example in the sea, and towed through the water by the vessel 51.

Water enters through the mouth 3a of the apparatus 1 and the internal pressure created in the apparatus by the relative water flow toward the trailing end of the apparatus and the largely impermeable walls causes the apparatus 1 to expand to the inflated configuration. The tapered walls 5c of the entry cone 5 assist with inflating the apparatus 1. As the apparatus 1 is towed, aquatic animals enter the inflated apparatus through the mouth 3a. If the animals do not exit via the escapements 9, 10, they move to the cod end portion 2.

As the apparatus 1 is towed, water flows relative to the apparatus in through the mouth 3a in the longitudinal direction of the apparatus. There is water flow out of the apparatus 1 through the escapements 9, 10 in each escapement module 6, 8, so that the flow rate of water inside the apparatus 1 generally reduces from the leading end 3a of the elongate lengthener portion 3 toward the cod end portion 2. Preferably, the water flow rate progressively slows in a series of controlled, graded steps occurring at each escapement module 6, 8, to the cod end portion 2, to provide a plurality of zones with different flow rates. These steps can be tailored to the physical and behavioural requirements of the target animals and depending on the fishing operation.

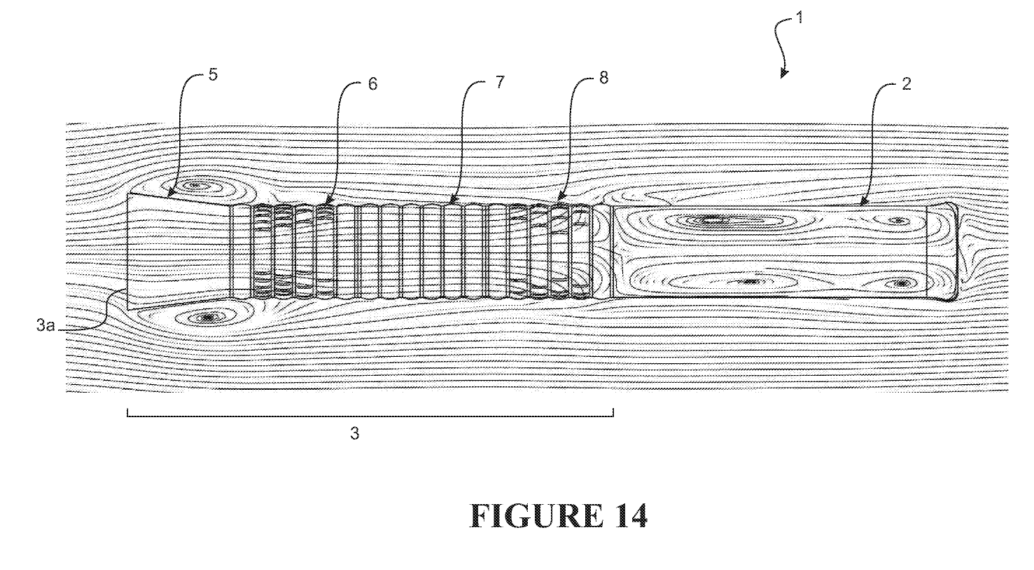

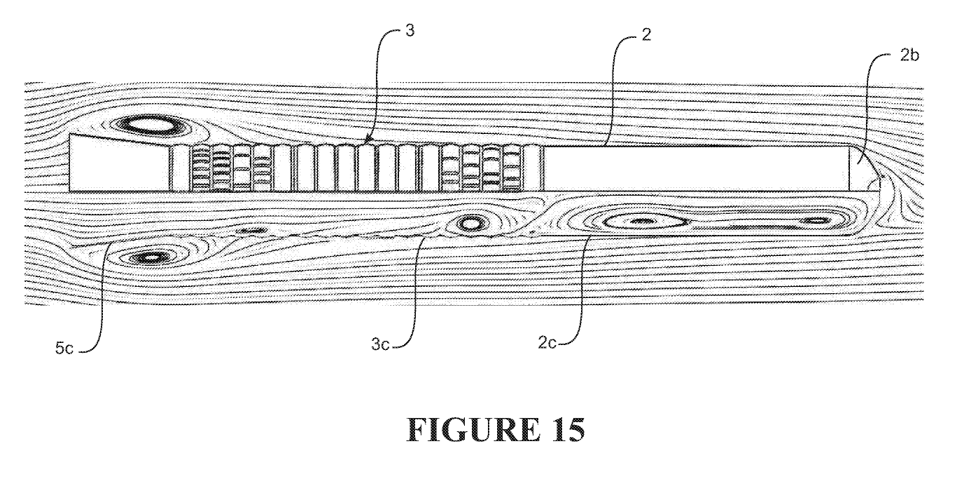

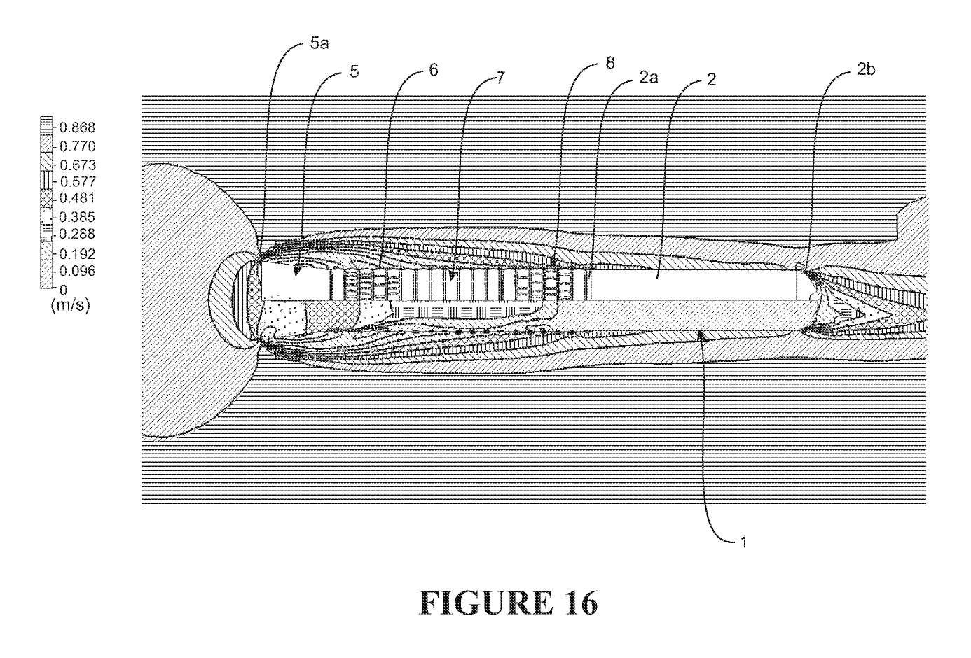

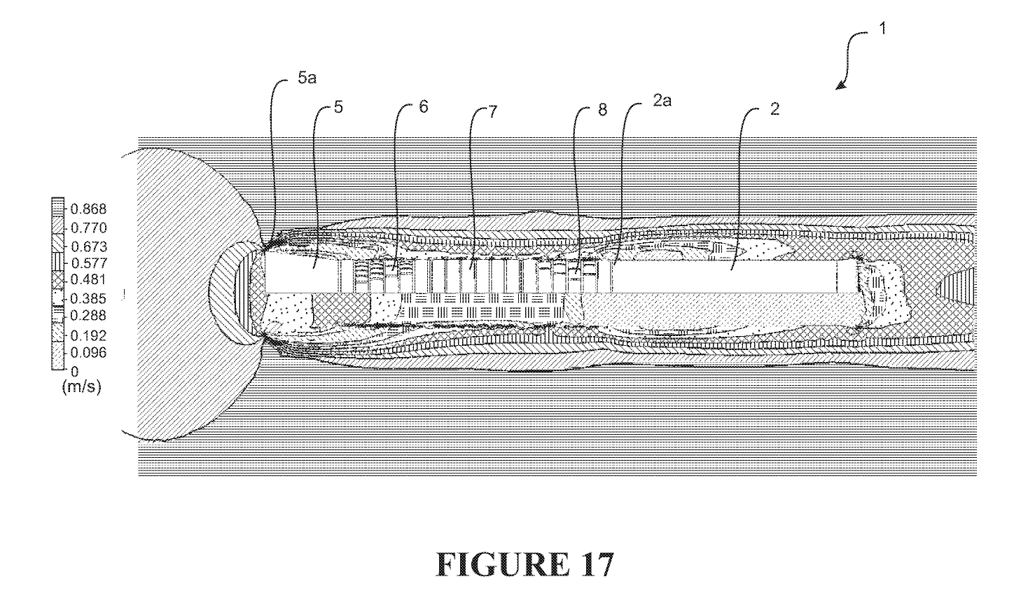

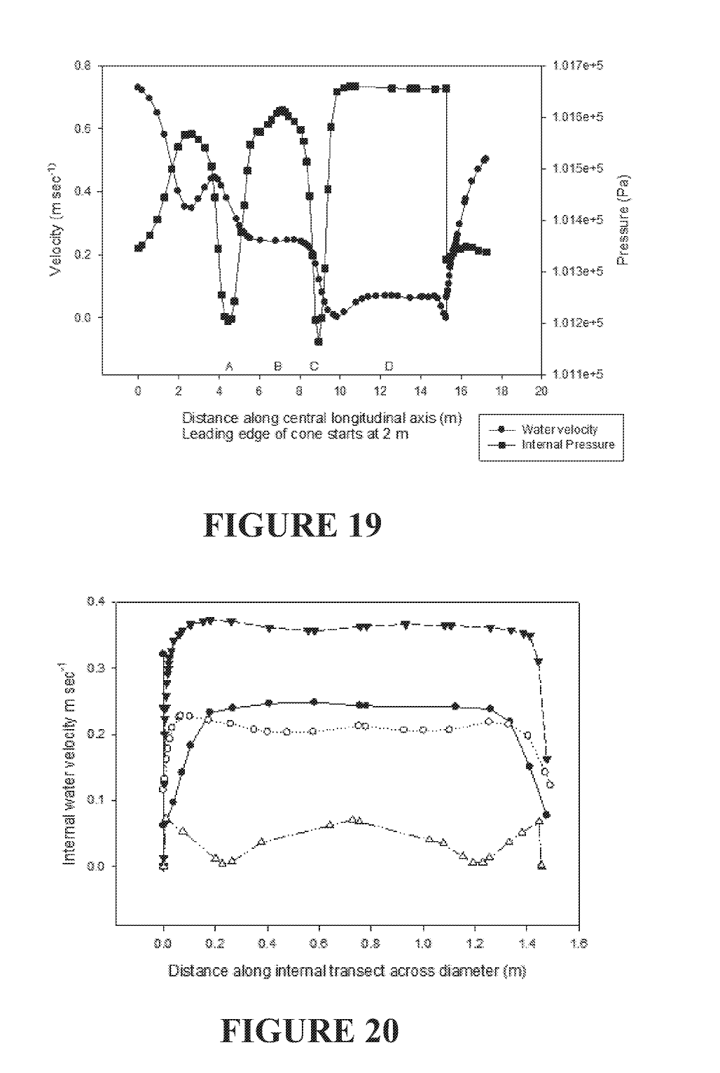

FIGS. 14 and 15 show streamlines showing water flow patterns and FIGS. 16 and 17 show computational models for the fluid dynamics in the apparatus 1 of FIGS. 1 to 15 when it is being towed at 3 knots (1.544 ms⁻¹) FIG. 19 is a graph showing internal pressure and water velocity relative to the apparatus 1 along its central axis. The models show the general decrease in flow rate from the mouth 3a to the cod end portion 2.

The graph in FIG. 19 shows that at the leading end 3a of the apparatus 1, the flow velocity along the central axis CA increases along the entrance cone 5 as the cone narrows from the mouth 5a to the trailing edge 5b adjoining the leading lengthener module 6. The flow rate then decreases significantly along the first escapement module 6 as water escapes through the escapements 9 in that module.

The flow rate in the apparatus is relatively constant and laminar or less turbulent along the extension module 7. The extension module provides a low-turbulence region for captured animals to be contained in medium velocity flowing water during harvesting. A longer medium velocity region may be provided by using a longer extension module 7, or a plurality of adjacent extension modules to increase the capacity of the apparatus for high volume fisheries. Alternatively, to increase capacity, additional length may be added to the apparatus in the form of further blank extension modules, and/or longer blank, escapement-free portions in the escapement modules 6, 8, at any point along the lengthener portion trailing the first region of escapements 9.

The flow rate then decreases again across the escapements 10 in the second escapement module 8 as more water escapes through the escapements 10 in that module. In preferred embodiments, the total area of the escapements 9 in the leading escapement module 6 is larger than the total open area of the escapements in the trailing escapement module 8, so the decrease in flow rate is greater at the first escapement module 6 than at the second escapement module 8. By way of example only, in one embodiment the ratio of the area of substantially impervious membrane to escapements in the leading escapement module 6 is about 93.5%, and the corresponding ratio in the trailing escapement module 8 is about 92.3%. In another embodiment, the difference could be greater. The escapements 9 in the first escapement module 6 may be larger than the escapements 10 in the second escapement module 8 to allow larger unwanted species to escape at the forward, higher velocity region of the apparatus 1.

Finally, the lowest velocity flow is in the cod end portion 2. Preferably, the apparatus is configured such that when the apparatus is towed through a body of water, the water velocity in the cod end portion relative to the apparatus is less than about 10% of the relative water velocity outside the apparatus, and preferably less than about 5% of the relative water velocity outside the apparatus. As an example, for an external water velocity V of 2 metres per second, velocity Vi in the cod end portion 2 is may be about 0.04 to 0.1 metres per second. That creates a very low turbulence refuge in the cod end portion, to provide a relaxed low flow rate environment for the aquatic animals. The apparatus 1 may be tailored to create lower or higher velocity flow in the cod end portion, as desired, by modifying design and placement of the escapements or escapement modules, and dimensions of the apparatus. Very low velocity flow is advantageous for low damage, low fatigue capture of easily exhausted species such as gurnard or John Dory, or capture of juveniles.

The low flow rate in the cod end portion 2 provides a low turbulence refuge for captured aquatic animals to swim in during the trawling process. This allows the aquatic animals to relax and minimises impacts between the aquatic animals and with the apparatus. The aquatic animals can readily swim along in the cod end portion 2 of the apparatus as it is towed through the body of water.

As shown in FIGS. 14 and 15, water circulates in the cod end portion 2. This low velocity circulation allows debris caught in the apparatus to be flushed out through the further forward escapements rather than catching against the back of the apparatus. For example, sand, shells, and stones may be flushed out and returned to the sea floor. As well as producing a cleaner catch, this reduces rough object contact with the captured animals. Crew labour onboard the vessel removing mud and sand from the catch and the apparatus is also reduced.

The number and size of the escapements 9, 10 in the escapement modules 6, 8 are selected to reduce the average flow velocity in the extension module 7 and/or the cod end 2, at a target tow speed, to well within the maximum sustained swimming speed (Ucrit) of the target organisms to be held in the respective segment. This prevents captured animals being exhausted and swept along by the water flow.

The membrane nature of the apparatus 1 allows the flow patterns within the apparatus to be adapted to specific selection tasks. A number of design elements can be modified to achieve specific selection and animal retention goals including escapement pattern, aperture configuration, module type, module numbers and size.

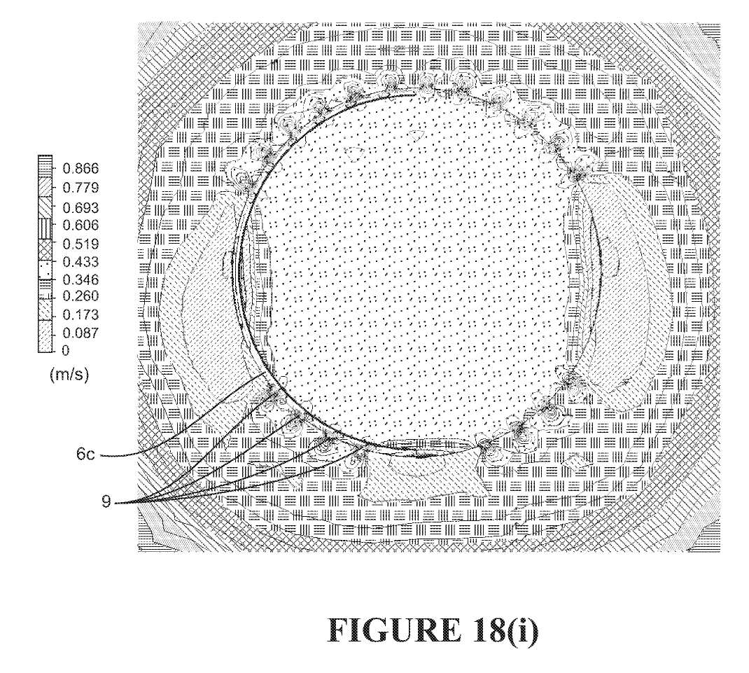

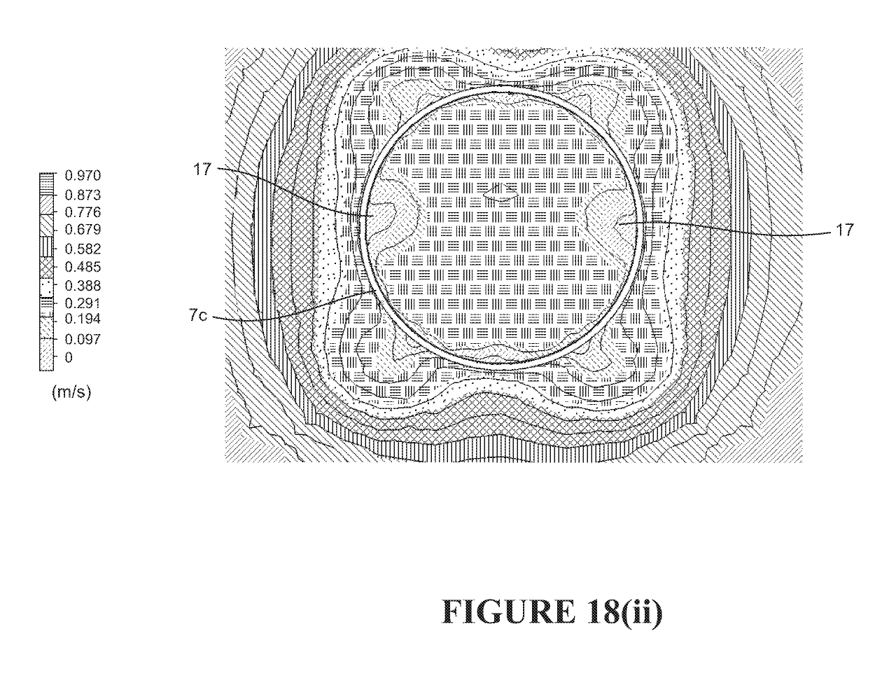

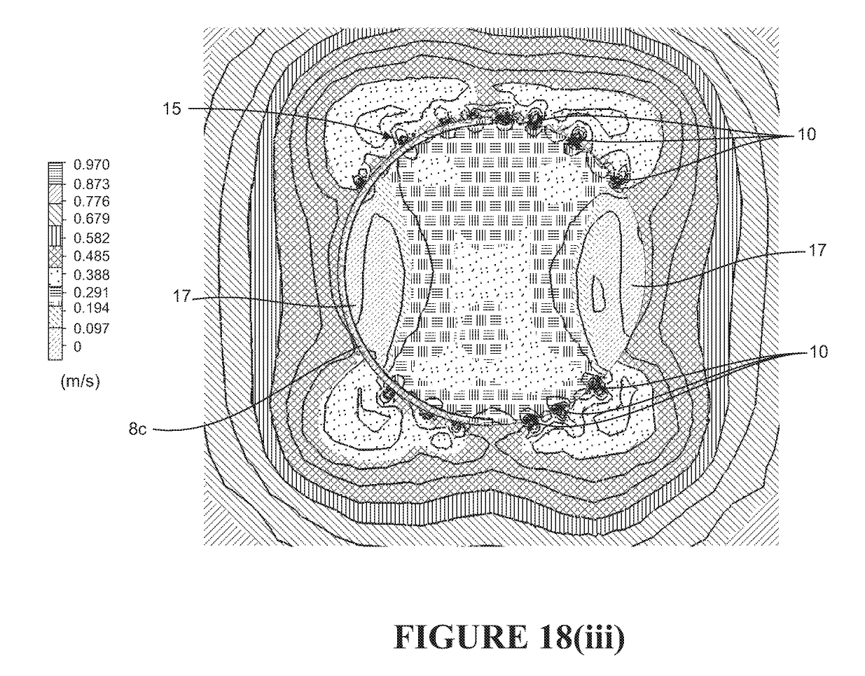

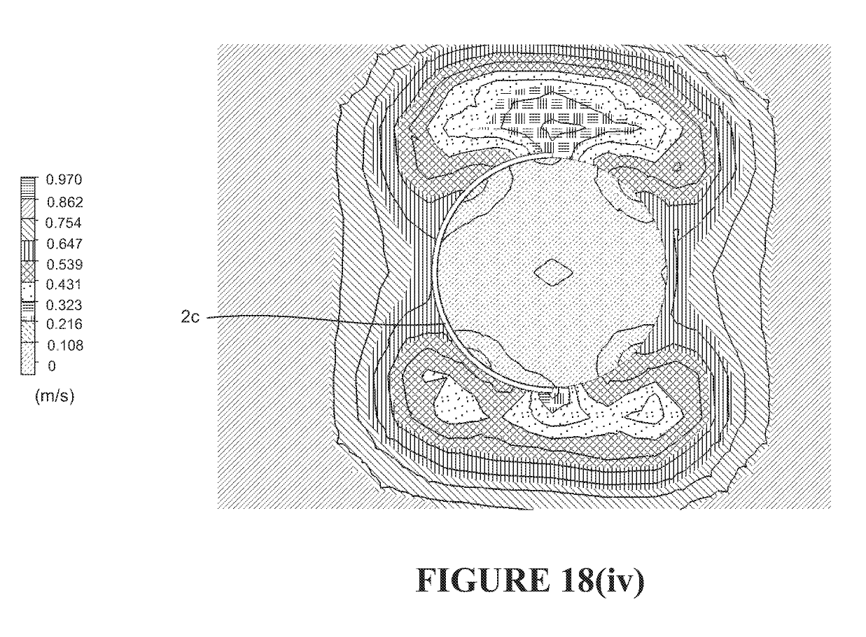

The average flow rate within the apparatus 1 is advantageously always less than the relative flow outside the apparatus. However the flow at any given point along the apparatus 1 is not consistent across the cross section of the apparatus. Instead, the flow comprises regions of low velocity flow and regions of higher velocity flow. FIGS. 18(i) to 18(iv) illustrate different flow velocities through each of the lengthener modules 6, 7, 8, and the cod end 2.

As illustrated in FIGS. 18(i) and 18(iii), flow in the escapement modules 6, 8, is directed towards the upper and lower escapements 9, 10 creating localised regions of high velocity flow 15 around each escapement 9, 10. Because the embodiment of FIGS. 1 to 4 does not comprise side escapements, a low velocity flow zone 17 or ‘dead zone’ is created along the sides of the escapement modules 6, 8. Flow in this zone has a reduced longitudinal velocity component, but may comprise an increased radial velocity component (see FIGS. 14 and 15). This low velocity zone 17 extends into the extension module 7 but is less pronounced. Small animals and low speed swimmers tend to congregate in the lower velocity areas. The low velocity side zones 17 allow these smaller animals to swim back up the apparatus, in the tow direction T. When the smaller animals exit these side zones 17 near the escapements 9, 10 due to low velocity recirculating water, the higher velocity flow around the escapements ‘sucks’ the smaller animals directly through the escapements with minimal wall contact.

Aquatic animals smaller than the escapements 10 in the second escapement module 8 are able to swim forward out of the low velocity cod end portion 2, along the low velocity side zones 17 and escape through those escapements 10. As shown by the streamlines, module contains a radial component that further assists in directing small and weaker fish towards the escapements 10 in the second escapement module 8.

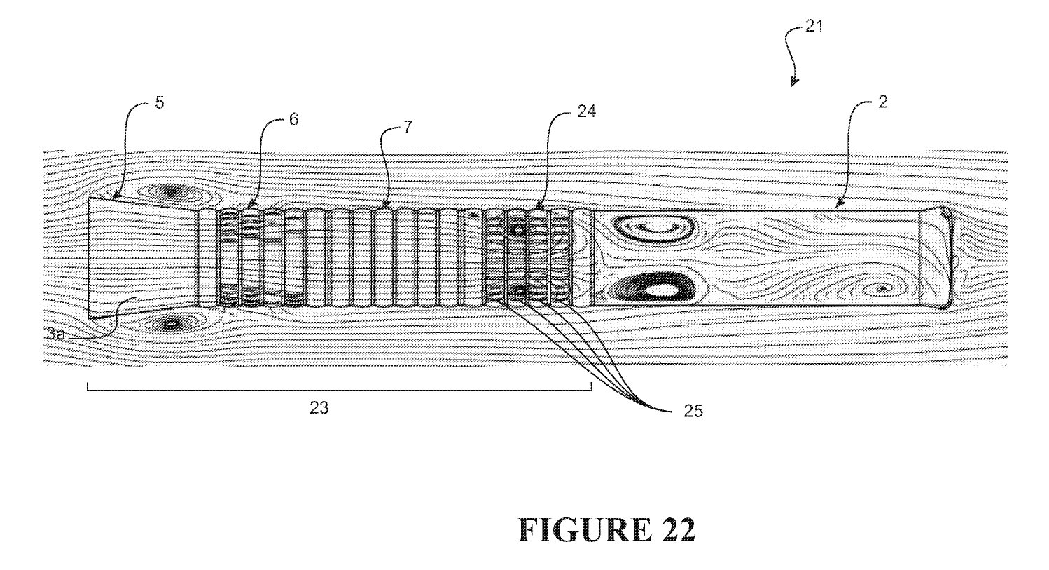

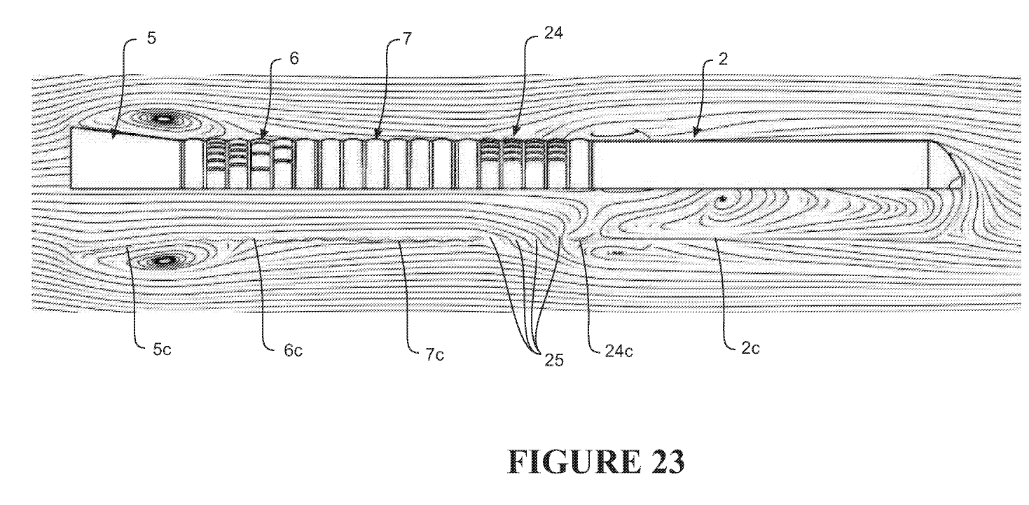

FIGS. 22 and 23 illustrate water flow in the second embodiment apparatus 21 of FIG. 21 having side escapements 25 in the second escapement portion 24. In that embodiment the gentle recirculation flow can be seen oriented at 90 degrees to the flow pattern seen in the first embodiment apparatus. This pattern would be useful in retaining fish such as barracouta that have strong instincts to move towards the sea surface. These fish will be re-circulated back towards the top surface of the apparatus while other species can be re-circulated or directly swept to the lateral escapements.

Larger, stronger aquatic animals can swim further forward in the faster moving water and into the first lengthener module 6, to the larger escapements 9, 10. If they are smaller than a given escapement, the animals can elect to exit the apparatus 1 through that escapement 9, 10.

In the embodiments of the harvesting apparatus, areas with increased flow rate are limited to very small, localised regions near some escapements 9, 10. Therefore, captured animals are held in a relaxed, low stress environment and can choose to exit through the escapements, rather than being forced through the escapements 9, 10. Fish or other organisms that are larger than the escapements 9, 10 will feel the pressure caused by the high velocity flow outside the apparatus, and will swim away from the escapements further into the interior of the apparatus. This is in contrast to existing trawl nets with escapement features, which try to direct fish to the escapements using ramps or other features to increase the flow rate inside the net in an attempt to match the velocity of the flow outside the net.

Because the animals in the cod end 2 are not crushed and are kept in a low stress state in which they are able to move about in the low speed cod end, they may be kept in the apparatus 1 for a much longer period of time than fish trapped in the cod end of a traditional net. This means the apparatus 1 may be held at depth and/or towed for a longer period of time than traditional nets, extending possible harvest durations. For example, it may be possible to tow the apparatus for more than 12 hours, or for several days while still harvesting relaxed, undamaged animals. Even if animals are damaged or stressed during initial capture, they are able to recover in the low flow in the cod end portion. With traditional nets, such extended trawls could result in extremely damaged, degraded catches.

The above method is specific to a method of trawling. Alternatively the apparatus 1, 21 may be used in other harvesting or aquaculture methods. For example, in one embodiment method the apparatus 1, 21 is placed and held stationary in a body of flowing water such as a river, with the leading end of the lengthener portion 3a upstream of the cod end portion 2. The current in the river produces relative water flow with the apparatus 1, 21.

In traditional seine fishing, much of the damage to the captured animals is incurred when the animals are forced in to the net cod end. In an alternative embodiment method the apparatus 1, 21 may be used in seine harvesting, for example by replacing the cod end of a traditional seine net with an apparatus according to the present invention. As the seine net and attached apparatus 1, 21 are winched in to harvest the accumulated animals, the animals flow into the apparatus 1, 21. The animals are then retained in the cod end portion 2 until they are retrieved from the apparatus using any of the methods discussed above. This technique is suitable for various types of seining, for example Scottish or Danish seine fishing, or lake seine fishing, for example to capture catfish. If the winch speed of the apparatus is slow, floats may be attached to the apparatus to keep the apparatus open.

Once a suitable quantity of aquatic animals has been captured, the apparatus is raised to the surface by the lines or cables 61 operatively connected to the front end 3a of the apparatus. Because the captured animals are able to be held in the cod end portion 2 for an extended duration, the transit of the apparatus from depth to the surface can be controlled at a slower rate. This decreases injury due to decompression injury and changes in water temperature. In a traditional net, damage due to a fast transit time to the surface must be balanced against damage caused by extending the time the catch is retained in the net.

As the apparatus 1 is brought to the surface, water ‘bleeds’ off through the escapements and the captured animals positioned further forward in the apparatus move back in the apparatus to the cod end. Because the rear end of the apparatus is full of water, if the full apparatus is held in the surface waters, the ‘washing’ effect of waves at the surface of the sea on the animals is decreased when compared with a traditional net.

In traditional nets, as the net is raised to the surface, fish are exposed. Damaged animals and detritus from the catch attract predictors and scavengers such as birds, seals, sea lions, sharks and fur seals. In the current system, the apparatus obscures and covers the catch so there is less food released for predators and scavengers as the catch is brought to the surface and onboard. Because the catch is contained in a body of water, this enables in-situ treatments of the catch. For example, anaesthesia or other prophylactic treatment, for example parasite or sea lice treatments, may be administered to a catch contained in the cod end portion 2 without removing the fish from water and before emptying the catch onboard the vessel.

### Alternative Embodiment Aquatic Animal Harvesting Apparatus

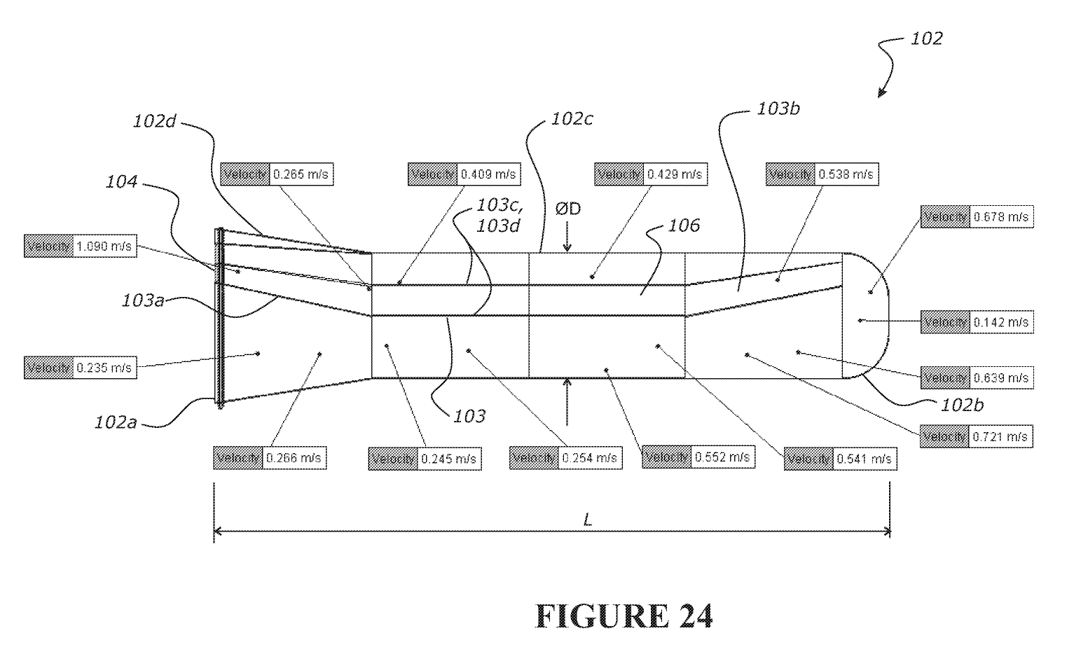

FIG. 24 shows an alternative embodiment cod end 102 for use in an apparatus for harvesting aquatic animals, such as the one described above. The cod end 102 may be used in place of the cod end 2 in FIGS. 1 to 23.

The cod end 102, herein ‘apparatus 102’, comprises a body with an open leading end 102a and a substantially closed trailing end portion 102b, and one or more side walls 102c extending between the open leading end 102a and the closed trailing end 102b. The open end 102a may be configured for attachment to an elongate lengthener portion 3, such as the one described above, and/or to sweep wings 63 and/or to the bosom 65 of the net as shown in FIG. 13, for connection to a towing marine vessel 51.

In the embodiment shown, at least a major portion (i.e., a majority) of the side wall(s) 102c, and the closed end 102b, of the apparatus 102 are substantially impervious to water. The side wall(s) 102c and the closed end 102b of the apparatus may be totally impervious to water. The walls and the closed end comprise a flexible membrane, such that the apparatus is collapsible and expandable between a collapsed configuration and an inflated or expanded configuration. The apparatus 102 is shown in the inflated configuration. The walls and the closed end may comprise an impervious material such as PVC or ripstop PVC, sail-making fabric, woven nylon airbag fabric, polyester, or polyethylene (such as ultra-high molecular weight polyethylene for example).

The empty apparatus 102 is likely, for example, to be stored on a boat in the collapsed state, for example, rolled up. When the apparatus 102 is towed in a body of water, such that the flow of water is substantially parallel to the longitudinal axis of the apparatus, internal water pressure causes the apparatus to self-inflate.

The walls 102c of the apparatus 102 may comprise a number of escapements or drainage holes to allow some flow of water out of the apparatus or to allow small fish to escape from the apparatus. The escapements may be apertures or may be in the form of flaps that seal closed under pressure. Additionally or alternatively, the closed end and/or the body 102c of the apparatus may have one or more water permeable seams that allow some seepage of liquid from the apparatus through the seams. For example, the wall 102c may be laced together along a longitudinal seam, and the lacing may be loose enough to provide some drainage.

In one embodiment (not shown) the apparatus may comprise a leading portion towards the open end 102a that has a plurality of escapements, and a trailing portion towards the closed end 102b that is substantially water-tight.

The closed end 102b of the apparatus 102 may be achieved by rolling the wall(s) 102c, then lacing reinforcing members on the outer surface of the walls 102c with a chain stitch. However, other seals are possible, or the closed trailing end may be configured to provide some water seepage through stitching or openings in the trailing end. The apparatus membrane wall 102c may comprise internal or external reinforcing such as that described in relation to FIGS. 5 to 9.

The apparatus body 102 has a tapered portion 102d at or adjacent the open end of the apparatus 102a. The tapered portion 102d assists with inflation of the apparatus 102 as it is towed under water during use.

In the inflated configuration shown, the apparatus 102 is substantially cylindrical (aside from the tapered portion 102d). Opposing sides of the apparatus wall 102c are substantially parallel when the apparatus 102 is inflated. However, portions of the wall 102c may bow or bulge outwards under the internal pressure in the apparatus 102, i.e. such that portions are inwardly concave. The substantially closed end 102b of the apparatus may be at least partially internally concave when the apparatus is expanded, as shown in FIG. 24.

The apparatus 102 comprises a baffle 103 positioned in an interior of the apparatus. The baffle 103 and the respective part of the side wall 102c together define the channel 106. The channel 106 extends along at least a major part of the length of the apparatus. The baffle 103 is attached to the side wall 102c of the apparatus along two opposed side edges 103c, 103d of the baffle 103.

The baffle 103 comprises a flexible membrane that is substantially impervious to water. The baffle may comprise lateral and/or longitudinal reinforcing.

The baffle 103 is flexibly movable between an inflated condition and a collapsed condition. The baffle 103 is shown in FIGS. 24 to 35 in the inflated condition. In this configuration the baffle 103 is concave relative to the respective portion of the side wall 102c, and the channel 106 has an approximately oval or circular cross-sectional shape. However, the channel 106 may have other cross-sectional shapes, or a cross-sectional shape that varies along the length of the channel 106.

In the inflated configuration, the cross-sectional area A1 of the channel 106 taken through a transverse plane in an intermediate region of the channel is about one-third of the cross-sectional area defined by the walls 102c taken in the same plane. However, the channel may have a larger or smaller cross-sectional area.

In the collapsed condition, the channel is obstructed and/or the cross-sectional area of the channel 106 is significantly reduced. For example, in the collapsed condition, the baffle may be convex relative to the respective body side wall portion, and is ideally positioned flush against the apparatus side wall 102c.

The baffle may comprise a plurality of apertures or permeable portions to assist with movement of the baffle from the open configuration to the collapsed configuration.

The channel 106 has a channel inlet 104 at or proximal the open end 102a of the apparatus, and a channel outlet 105 proximal the closed end 102b. For example, the channel outlet 105 may be positioned adjacent or substantially at the closed end 102b of the apparatus body. In the embodiment shown, the channel 106 has opposed open ends defining the channel inlet 104 and the channel outlet 105 between the baffle and the apparatus wall 102c. Alternatively, the baffle 103 may extend to the closed end 102c of the apparatus 102 and the channel outlet 105 may be provided by one or more apertures in the baffle 103 in a region of the baffle proximal the closed end 102b.

The embodiment shown in FIGS. 24 to 35 advantageously is easy to clean as debris can be readily flushed through the channel outlet 105. Embodiments having a channel outlet 105 provided by a number of apertures in the baffle 103 may be constructed such that, in an unrolled condition, the baffle 103 extends substantially to or beyond the unrolled trailing end 102b of the apparatus 102. The baffle is rolled up together with the cod end portion wall to join the baffle 103 to the closed end 102b. The closed end 102b can be unstitched and unrolled to enable easy cleaning of the channel 106 by flushing water through the unrolled end of the channel.

In the embodiment 102 shown, an end portion 103b of the baffle 103 near the closed end 102b is shaped and/or attached to the side wall 102c such that, in the inflated condition, the channel 106 tapers inwards, such that the cross-sectional area of the channel 106 reduces towards the channel outlet 105. The tapered portion 103b proximal the closed end of the apparatus body 102 provides back pressure in the channel 106 to maintain the baffle 103 in the inflated condition.

An end portion 103a of the baffle 103 near the open end 102a is also optionally shaped and/or attached to the side wall 102c such that, in the inflated condition, the channel 106 tapers inwards towards the open end 102a of the apparatus. This tapering simplifies construction and opens out flow at the open end 102a.

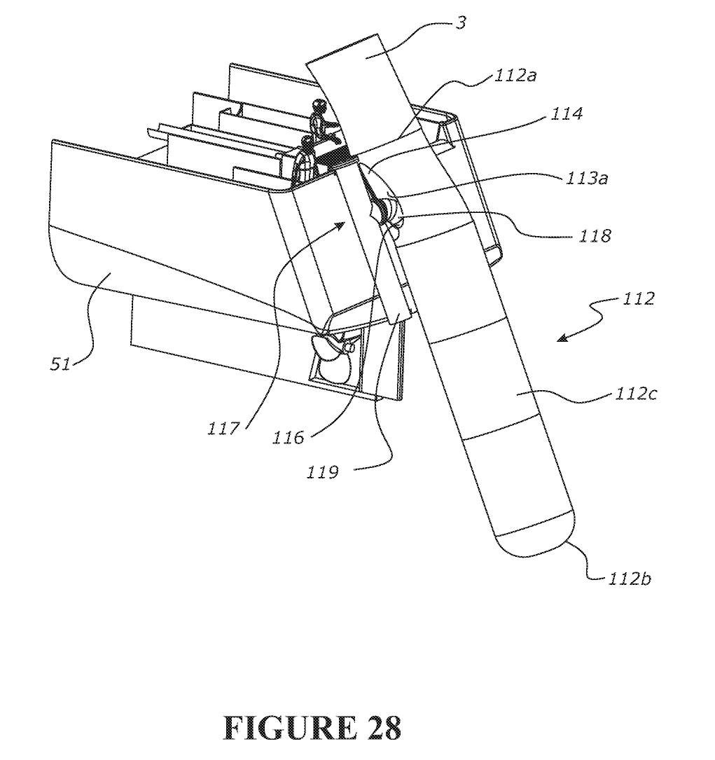

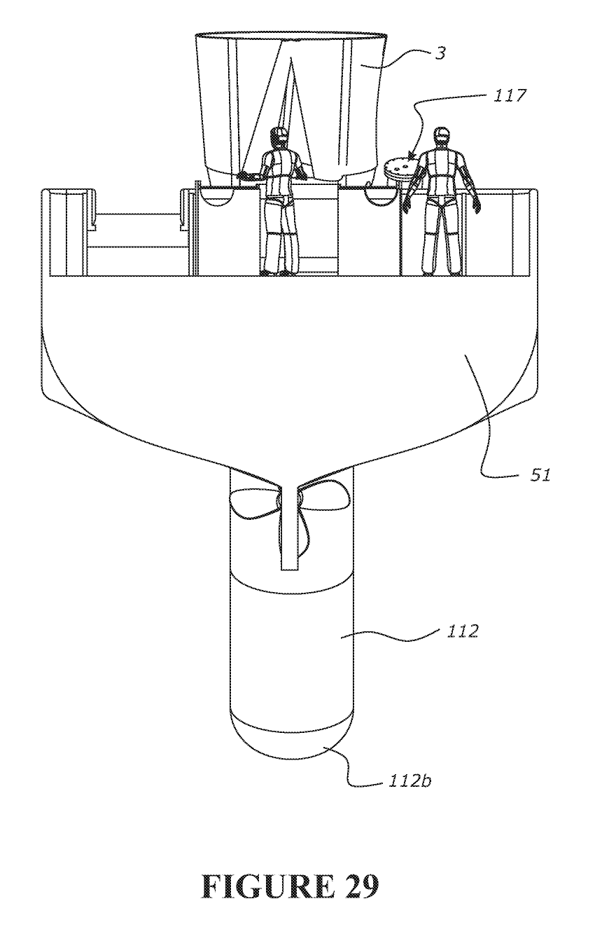

In the embodiment shown, the baffle 103 and channel inlet 104 are positioned internally in the apparatus 102. The inlet 104 is within and bounded by the apparatus wall 102 at or near the open end 102a of the apparatus body. Alternatively, a leading end of the baffle may be attached to the apparatus wall at or towards the open end 102a and the channel inlet 104 may be provided in a side wall of the apparatus, for example, through an aperture in the apparatus wall 102. FIGS. 28 and 29 illustrate an embodiment 112 with a side channel inlet.

The apparatus 102 comprises a single baffle 103 and channel 106, but alternatively may have a plurality of baffles and/or channels.

In a further alternative, the baffle could be provided externally, for example by attaching the edges of the baffle to an exterior surface of the apparatus wall 102c. In such an embodiment, the outlet from the defined channel 106 would be provided by one or more apertures in the apparatus wall 102c.

The open end 102a of the apparatus 102 may be attached to an elongate lengthener portion such as the ones described above with reference to FIGS. 1 to 23. In alternative embodiments, rather than having a circular cross section, the cod end apparatus 102 and/or any attached lengthener portion may have a different cross-sectional configuration when the apparatus is expanded, such as an elliptical or polygonal configuration. By way of example, the lengthener portion may have a substantially square, rectangular, hexagonal, or octagonal cross-sectional configuration when the apparatus is expanded.

Method for Emptying Apparatus

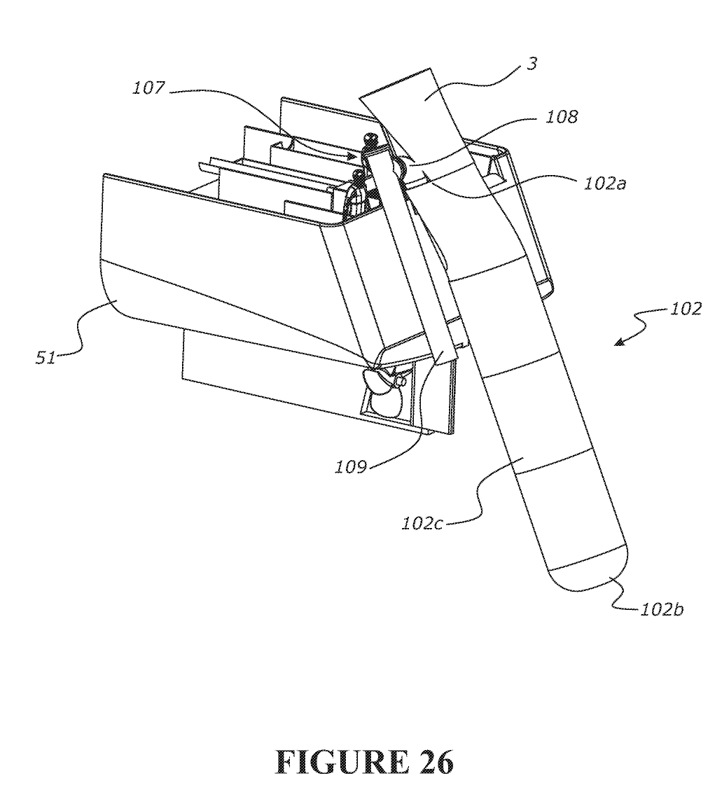

FIGS. 26 to 37 illustrate steps for an exemplary method of extracting harvested aquatic animals from the apparatus 102 onto the towing vessel 51.

In a first step, the apparatus 102 is raised its open end 102a, for example, using cables. Once the open end 102a of the apparatus 102 is near the water surface, the open end 102a of the apparatus is pulled forward and upwards by cables or lines operatively connected to the open end 102a of the apparatus, to the vessel 51 so that the open end 102a of the apparatus is positioned near the deck of the vessel 51, preferably at the vessel's stern. The raised apparatus 102 contains aquatic animals held in a volume of water.

If the apparatus 102 comprises escapements or drainage holes in the walls 102c or closed end 102b, or permeable seams, water seeps from the apparatus 102 as it is raised. This advantageously reduces the weight that lifting equipment on the vessel 51 must handle while still maintaining the aquatic animals in a pool of water to reduce damage to the animals.

If the open end 102a of the apparatus 102 is attached to a lengthener portion 3 (shown in part) and/or sweep wings, the apparatus 102 may be lifted by way of the lengthener portion or sweep wings. The lengthener portion and/or sweep wings are raised above or onboard the vessel and may be partly or fully detached from the apparatus 102 or moved out of the way of the open end 102a of the apparatus 102. For example, the lengthener portion 3 could be opened or ‘unzipped’ vertically and horizontally to form an opening through which aquatic animals can be emptied out of the apparatus 102.

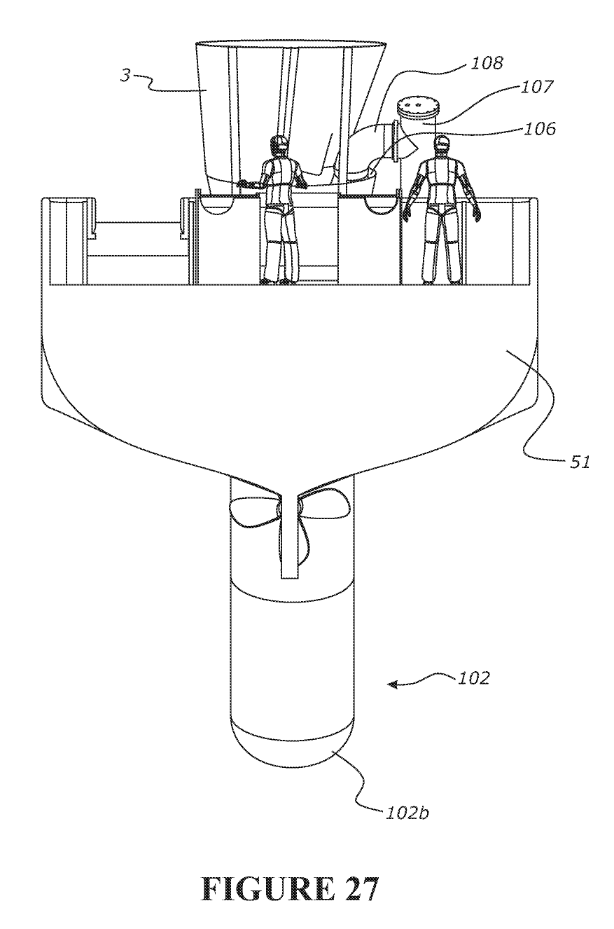

In a first step, the lifted apparatus 102 is arranged with its open end 102a positioned above its closed end 102b. For example, the apparatus 102 may be substantially upright as shown in FIGS. 26 and 27. The apparatus may alternatively be oriented on a different angle from that shown. In this arrangement, a lower part of the apparatus 102 is still positioned in the body of water and partly supported by the body of water.

Having the apparatus 102 partly supported in the body of water advantageously reduces the load that needs to be handled by vessel lifting systems compared with traditional trawl net processing, in which the entire catch and trawl net are typically lifted from the sea and above the deck of the vessel. This also increases the volume of animals that can be held in the cod end without the animals incurring high levels of damage. In the present method, the vessel lifting system only needs to support some of the catch and trawl apparatus because the portion of the catch and apparatus that remains in the body of water has some buoyancy and is supported by the body of water.

One benefit of this arrangement is the potential for smaller vessels or vessels with lower capacity lifting gear to handle larger catch volumes because the entire weight of the catch does not need to be lifted by the onboard lifting system. Small vessels are therefore able to use the system described herein to carry out longer trawls and process larger volumes of fish.

Positioning the apparatus off the stern of the vessel 51 provides for improved stability compared to traditional systems, particularly for vessels with side-lifting systems. Eliminating the overhead lift of a full catch also decreases safety hazards onboard.

In this arrangement, the pressure head provided by water contained in the apparatus 102 gives some rigidity and stability to the apparatus. However, an upper part of the apparatus 102 may optionally be secured or restrained relative to the vessel 51 to minimise movement of the apparatus relative to the vessel. For example, the apparatus may be held in a chute or cradle attached to the vessel 51, strapped in place, or otherwise coupled by way of a suitable flexible or rigid coupling.

Once the apparatus 102 is positioned relative to the vessel 51, a pump 107 onboard the vessel 51 is coupled to the apparatus 102. An outlet 108 of the pump 107 is inserted into the channel inlet 104 or otherwise coupled to the channel inlet 104.

The pump outlet 108 may have a 90 degree elbow bend, as shown, to direct water from the pump downwards into the channel 106. The pump outlet 108 may comprise a flexible coupling to accommodate relative movement between the apparatus 102 and the pump 107.

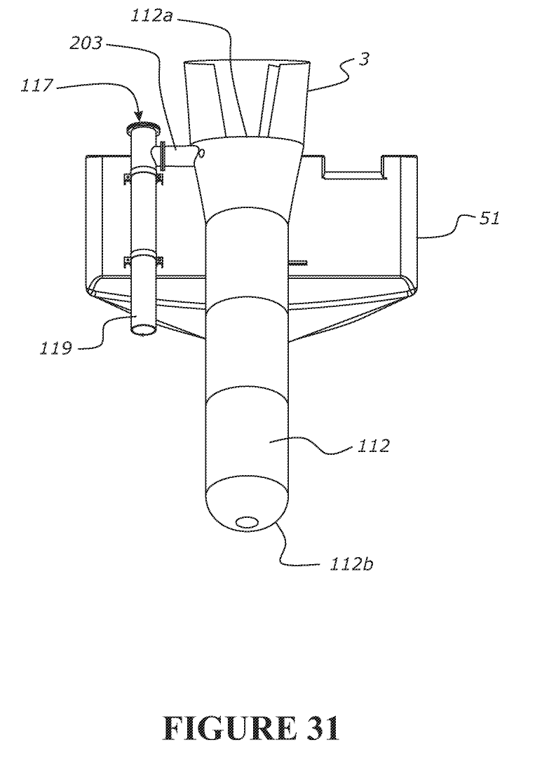

FIGS. 28 and 29 show an alternative embodiment apparatus 112 in which the channel inlet 114 is provided through an aperture in the side wall 112c of the apparatus 112. In that embodiment, the pump outlet 118 is positioned lower than in the arrangement of FIGS. 26 and 27 for alignment with the side inlet 114. This side entry arrangement advantageously enables the apparatus 112 to be slid onto the pump outlet nozzle 118, with the nozzle 118 captured in a tapered entry port, minimising manual handling of the couplings. Such an arrangement may be particularly suited to large vessels where the apparatus 112 can be hauled onto the pump outlet nozzle 118. The side channel inlet 114 may be provided substantially at the open end 112a of the apparatus as shown in FIG. 31, or may be positioned further down the apparatus as shown in FIG. 28 for example. Other than the positioning and features described in relation to the side channel inlet 114 above, the features and functionality of this embodiment apparatus 112 are the same as for apparatus 102, and like reference numerals indicate like parts with the addition of 10 to each reference numeral.

In contrast, the top entry arrangement of the first embodiment apparatus 102 may be more suited to smaller vessels, where the pump couplings can be easily accessed and handled by one or two people.

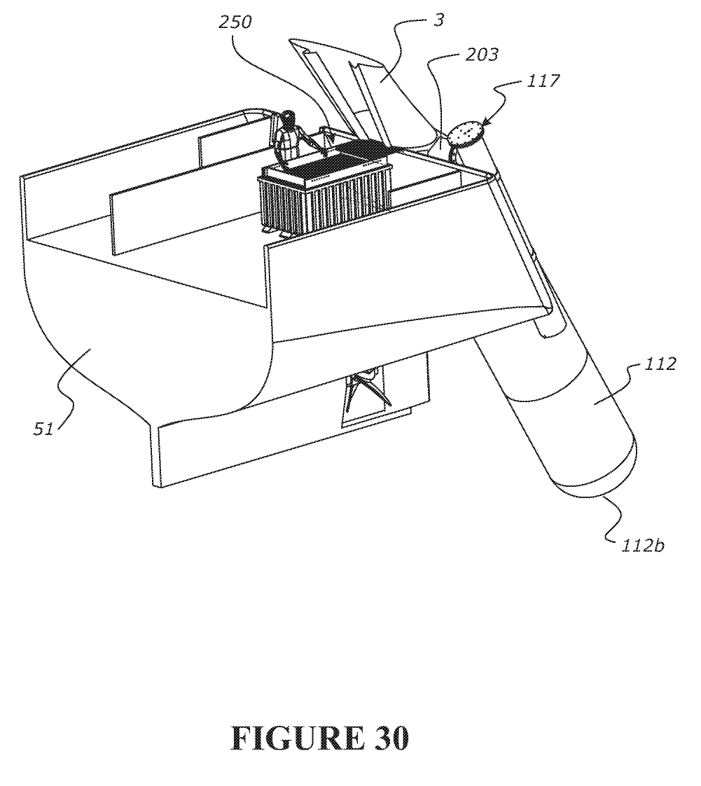

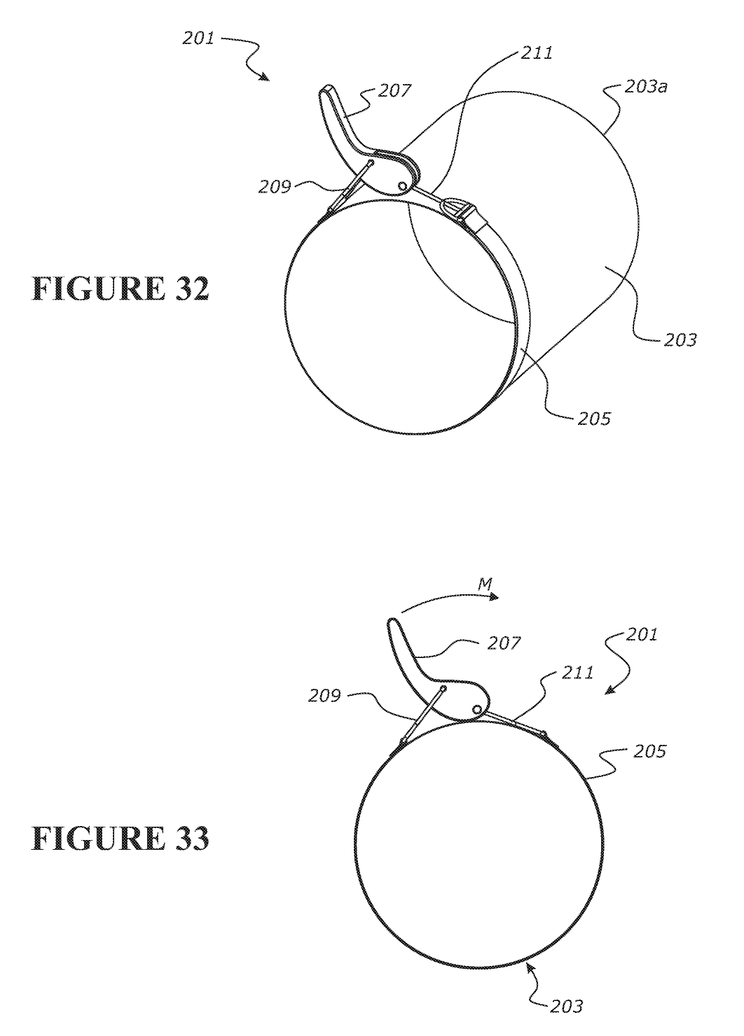

FIGS. 30 and 31 show a method of coupling the apparatus 112 to the pump outlet 108 or 118 using a flexible coupling arrangement 201 (FIGS. 32 and 33). The coupling 201 comprises a coupling tube 203 fabricated with PVC ‘curtainsider’ material; however, the coupling tube 203 could comprise other suitable materials. The coupling is attached to the apparatus 102 and extends into the channel inlet 104.

A flexible collar 205 is connected to the coupling tube 203 at one end of the tube 203. A cam lever 207 is attached to two ends of the flexible collar 205 by way of pivoted links 209, 211. To couple the tube 203 to the pump outlet spigot 108, the flexible collar 205 is placed over the outlet 108 and the cam lever 207 is pivoted in the direction M shown in FIG. 33, to tension the collar 205 and lock the collar 205 in the tensioned configuration.

The locking mechanism is adjustable, for example using a thread on one of the pivoted links 211, easy to set and unset, and can be tensioned to automatically release if the bag movement is too great. The coupling tube 203 may be configured to be at about 90 degrees to the longitudinal direction of the apparatus 102 when the collar 205 is clamped to the pump outlet 108.

The collar 205 preferably comprises webbing that is stiff enough such that the collar 205 is easy to slip over the pump outlet 108, but flexible enough to be able to be rolled with the apparatus 102 for storage.

The flexible cam coupling arrangement 201 provides a light weight, flexible coupling that is compatible with gear storage and net rollers. The coupling tube 203, collar 205 and cam lever 207 can be folded back inside the apparatus 102 during operation to prevent snagging on the ocean floor or on trawl equipment. Alternatively, the coupling tube 203, collar 205 and cam lever 207 can be externally secured to the apparatus 102, for example, with rope.

A portion of the pump outlet 108, 118 or the flexible collar 203 may comprise one or more openings to enable air to be vented to atmosphere, to minimise the amount of air that is driven into the trailing closed end 102b, 112b of the apparatus as water is pumped into the apparatus through the channel 106, 116.

Alternative methods of clamping or otherwise attaching the apparatus 102 to the pump outlet 108 are envisaged. For example, the pump 117 may be suspended within a coupling tube with anti-rotation lugs to reduce torque on start-up and stop of the pump. Alternatively, the pump outlet may be hard mounted to a coupling tube.

In the embodiment shown, the pump 107, 117 is a vertical propeller pump with an inlet 109, 119 configured for drawing water from the body of water, for example sea water, into the pump 107. Alternatively, the pump 107, 117 may be any other suitable pump. The pump inlet 109, 119 may alternatively pump water from another source, for example a water supply on board the vessel 51. The water may be untreated or may, for example, be cooled.

Once the pump is coupled to the apparatus 102, 112, the pump 107, 117 is actuated, drawing water through the pump inlet 109 and delivering a flow of water through the pump outlet 108 into the channel 106 via the channel inlet 104, 114. Water pumped into the channel 106, causes the baffle 103 to move to the inflated position, increasing the cross-sectional area of the channel. The lower tapered portion of the channel 106, if present, may help with this inflation by increasing back pressure in the channel 106.

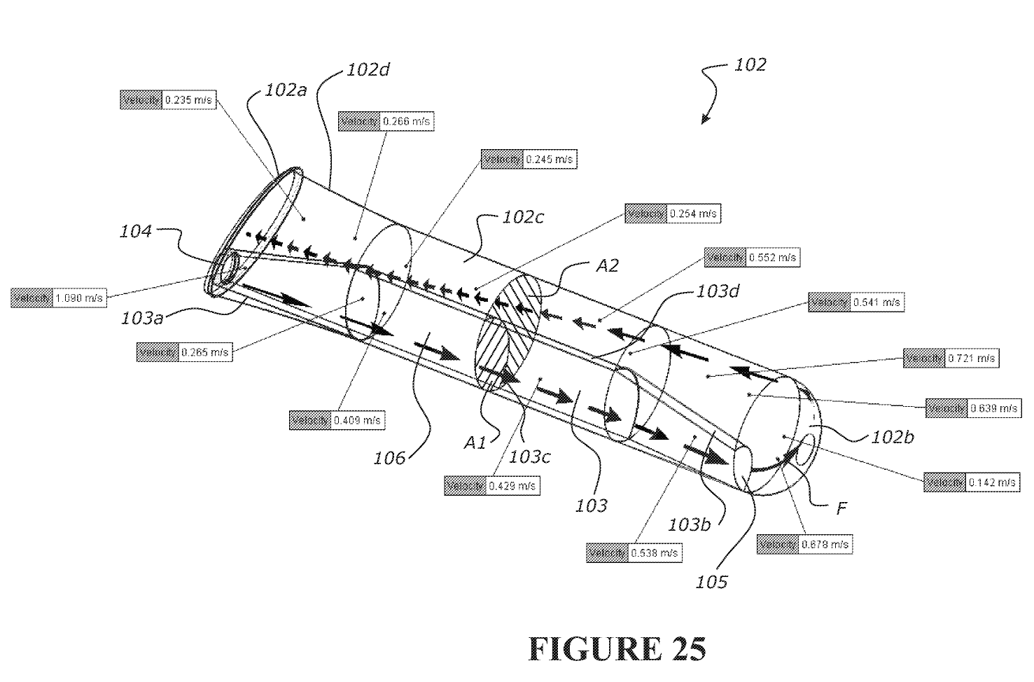

FIG. 25 illustrates net flow F through the apparatus 102. Water flows from the inlet 104, down the channel 106, out of the channel outlet 105, and into an internal region of the apparatus 102 proximal the closed end 102b. The introduced water thereby applies a positive water pressure to the contents of the apparatus from the closed end 102b of the apparatus.

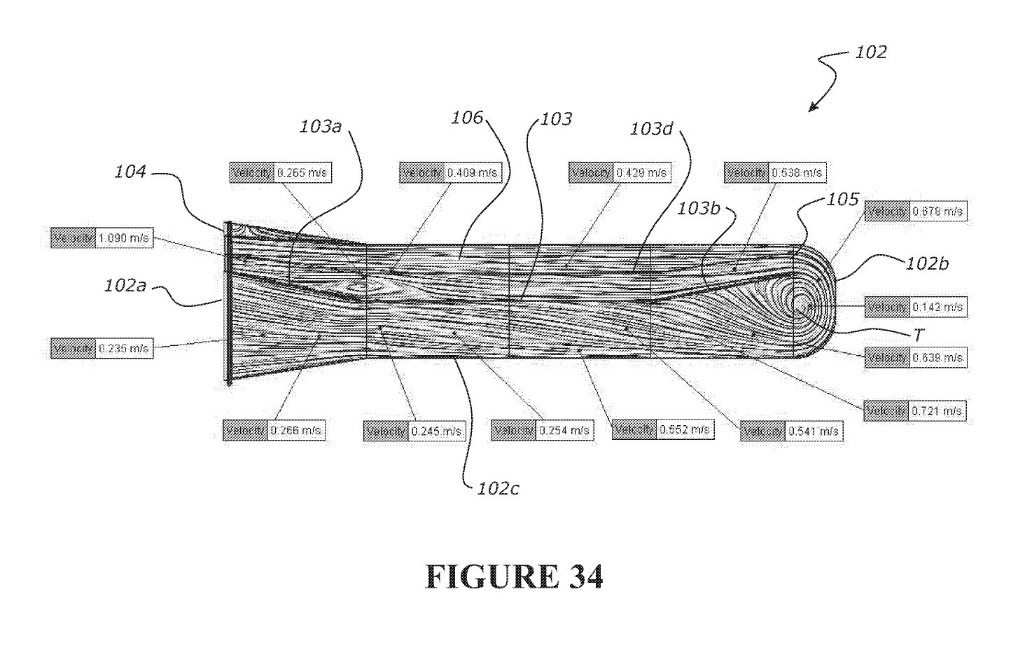

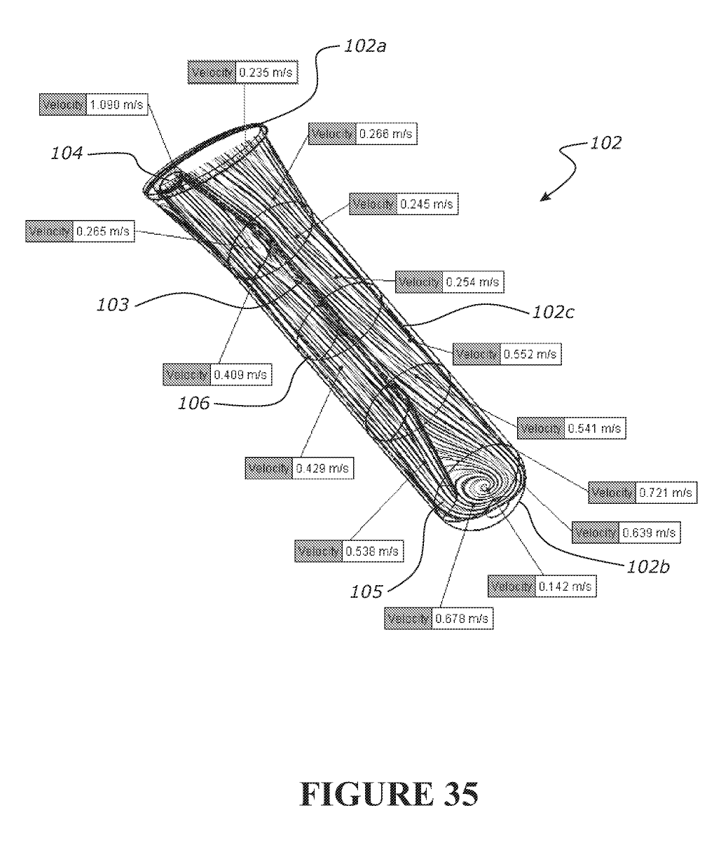

FIGS. 34 and 35 show modelled flow characteristics for the exemplary apparatus 102 of FIGS. 24 and 25 with an input (pump output) flow rate of 250 litres per second. The figures show that the water velocity increases at the tapered end 103b of the channel and causes some turbulence near the closed end 102b of the apparatus 102. The amount of turbulence increases with increased input flow rates and can aid in extracting animals from the apparatus by causing fish to become disoriented and more easily swept along by the flow out of the apparatus. Turbulence may also help in eliminating small animals if escapement holes are provided.

The flow rate provided by the pump through the channel 106, 116 is selected such that it is sufficient to inflate the channel 106, 116 and that the positive pressure created by flow from the channel outlet 105 into the region of the apparatus proximal the closed end 102b, 112b is sufficient to cause water to flow upwards, as indicated by the flow arrows F, towards and out the open end 102a, 112a of the apparatus. As water flows from the closed end 102b, 112b to the open end 102a, 112a, aquatic animals are urged along the apparatus by the flow and at least some animals are transported out the open end 102a, 112a of the apparatus 102, 112.

If the apparatus 102 comprises escapements, drainage holes, or tears in the walls 102c or closed end 102b, or permeable seams, some of the water pumped into the apparatus 102, 112 will be lost through those openings. This does not necessarily affect the effectiveness of the system at removing animals from the apparatus. A higher flow rate of water into the apparatus is necessary to cope with such losses in pressure head. The pump will be sized to accommodate such head losses.

The pump 107, 117 is preferably a variable speed pump. For example, the pump 107, 117 may be driven by a variable speed drive unit (not shown). The flow rate from the pump outlet 108, 118 into the channel inlet 104, 114 may be selected or varied to extract a specific type or types of animal species. A low flow rate may be used to extract smaller or more buoyant animal species; a higher flow rate may be used to extract larger animal species. The water flow rate may be varied throughout the extraction process to extract different species at different stages of the process and/or to vary the extraction rate at different stages. This may be helpful for sorting species.

The speed of the pump 107, 117 or pump drive unit may be manually controllable, and/or the pump may be coupled to a controller for automatic speed variation. The controller may an electronic or hardware controller that is programmed to operate the pump 107, 117 according to a desired delivery sequence, for example, periodically or continuously increasing or decreasing the speed of the pump 107, 117 and thereby the flow rate from the pump outlet 108, 118. For example, the pump speed may be slow initially, to allow air to be vented from the apparatus, and then increased to match the rate of processing and selection.

Aquatic animals from the apparatus 102, 112 are extracted to the marine vessel 51 but alternatively may be extracted to another facility, for example, for sorting, processing and/or storage.

As illustrated in FIG. 30, aquatic animals extracted from the apparatus 102, 112 may be passed over a sorting grill or grate 250 to remove juvenile, undersize, or unwanted animal species, which fall through openings in the grill or grate. The sorting grill or grate may be arranged such that animals that fall through the grill or grate fall straight back into the body of water without being subject to unnecessary handling. This may improve the survival rate of juvenile, unwanted, and undersize animals.

After the animals are extracted, they may be processed and sorted on board the vessel 51. The extraction rate of aquatic animals may be controlled to match the rate of processing to avoid or minimise extracted animals sitting on the deck of the vessel awaiting processing.

Once animals have been extracted from the apparatus 102, 112, the pump 107, 117 is turned off, and the closed end 102b, 112b of the apparatus 102, 112 may be raised out of the body of water from its closed end 102b or open end 102a. Water drains from the apparatus 102, 112 from any escapements and/or from the open end of the apparatus 102a.

The cables and apparatus 102, 112 are then reeled in and rolled up for storage around a drum on the marine vessel 51. The apparatus 102, 112 preferably does not comprise any rigid stiffening components or rigid grid components. That simplifies onboard handling or the apparatus and means the apparatus can be handled using existing equipment for handling traditional nets, for example rolled up around a drum on the rear of the vessel for compact storage. Alternatively the apparatus could be folded or otherwise rolled for storage. This ease of storage is in contrast to alternative fish pumping systems that rely on suction pumping fish. In those systems, the pumping pipes and equipment are often rigid, very mechanical, and/or bulky to cope with the negative pumping pressures and, therefore, cannot be rolled or folded with the trawl for easy storage.

Alternatively, the apparatus may be lowered back into the body of water for further harvesting of aquatic animals. Some fishing vessels may operate a twin system utilising two preferred form apparatuses. While a first apparatus is being emptied and the catch processed on deck, a second apparatus may be towed to gather a second catch. The empty first apparatus may then be lowered for a further catch as the second apparatus is raised for emptying and processing.

In some of the methods of emptying the apparatus 102 or 112, all or substantially all of the aquatic animals may be removed from the apparatus 102, 112 by the fluid flow through the apparatus. In other methods of emptying the apparatus 102 or 112, some aquatic animals may remain in the apparatus after the pump 107, 117 has been operated. For example, these remaining aquatic animals may be strong-swimming palegics, non-buoyant animals, and/or dense fish.

In those other methods, subsequent step(s) may be taken to empty some or all of any aquatic animals remaining in the apparatus 102 or 112, after using the introduced flow of liquid to transport aquatic animals contained in the apparatus out of the open end of the apparatus.

For example, the apparatus 102, 112, could be lifted onto the marine vessel from its leading end 102a, 102b and the remaining aquatic animals drained from the apparatus 102, 112. Because at least the majority of the animals have been removed during the liquid flushing method described herein, there will not be significant weight remaining in the apparatus 102, 112. As the apparatus 102 is hauled onto the vessel, the water in the apparatus 102 cushions the remaining aquatic animals, thereby minimising damage to the aquatic animals from impact with the vessel.

Remaining catch may then be emptied out of the leading end 102a of the apparatus. Alternatively, remaining catch may be emptied by opening the trailing end 102b of the apparatus 102 to allow the passage of aquatic animals from the interior of the apparatus 102 to the exterior of the apparatus. In such an embodiment, the trailing end 102b may comprise a suitable feature such as a zip-type or cord arrangement, for example, so it may be closed off for trawling and opened to release the catch.

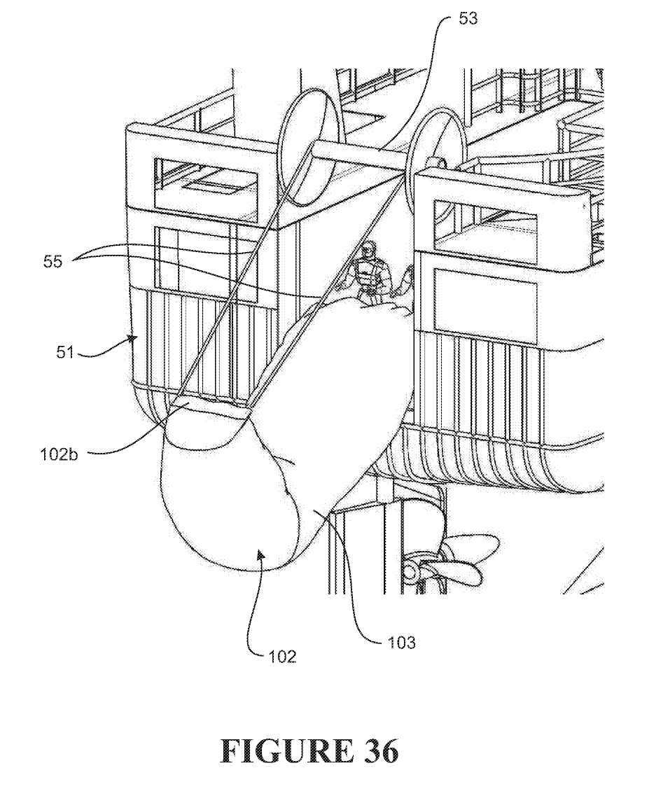

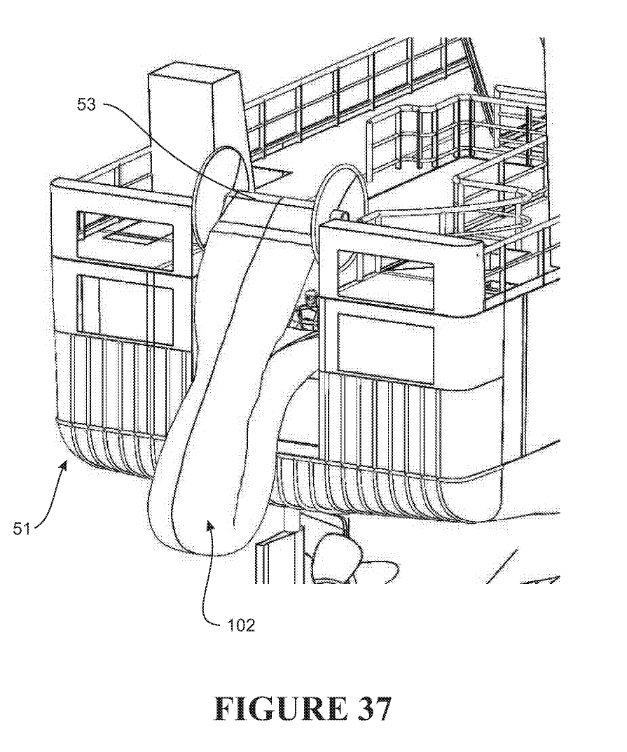

An alternative embodiment of the method comprises lifting the substantially closed end 102b, 112b of the apparatus to drain at least some of any remaining aquatic animals out of the open end 102a, 112a of the apparatus. FIGS. 36 and 37 illustrate steps of a method of raising the apparatus 102 from the body of water and emptying the remaining catch onto the towing vessel, after the liquid flushing process. The same method could be used with apparatus 112.

At least one rear lift line 55 is attached to the rear end 102b of the apparatus 102 and to a winch, drum 53 or other device onboard the vessel, to reel in the line. As the rear end 102b of the apparatus is raised, the apparatus 102 ‘folds’ and the remaining catch and water spill out of the open front end of the apparatus 102 and onto the vessel 51. FIGS. 36 and 37 illustrate the method of ‘folding’ the apparatus by raising the rear end 102b of the apparatus. The rear end 102b of the apparatus is moved upwards and forward so that a rear part of the apparatus overlaps and is positioned vertically higher than a front part of the apparatus.

When the apparatus 102 is removed from the body of water, water may be retained in the apparatus 102 due to its impervious walls and closed end 102b, rather than draining through the sides as in a traditional net. This water allows remaining aquatic animals to continue swimming in the apparatus has the apparatus has been raised out of the water, reducing contact between aquatic animals and contact with the wall(s) of the apparatus, reducing the induced stress.

The rate at which the remaining catch is emptied is controllable by controlling the rate at which the rear lift line(s) 55 is/are reeled in. This allows steady, controlled release of the catch, effectively operating the apparatus 102 as a fish pump to fluidly convey the fish onto the vessel 51. It is possible to release the remaining catch at a rate that matches the processing rate onboard the vessel, thereby reducing the time that the animals are exposed on the deck of the vessel 51 awaiting processing.

It is not necessary to lift the entire apparatus 102 from the water to empty the remaining aquatic animals. By only raising the trailing end 102b of the apparatus 102 while keeping some of the apparatus 102 in the water, the hydrostatic pressure from the raised portion acts to ‘pump’ out some of the water and some of the catch. Because it is not necessary to lift the entire apparatus at once, and because the majority of the aquatic animals have been removed by the liquid flushing process discussed above with reference to FIGS. 26 to 35 before lifting the trailing end of the apparatus, a lower capacity of the winch may be used. This provides the advantage that smaller vessels can be used for larger catches. This also reduces free surface effects from water sloshing around on the vessel because much of the weight of the full apparatus is suspended off the back of the vessel and supported in the water during the liquid flushing process.

Some fishing vessels may operate a twin system utilising two preferred form apparatuses. While a first apparatus is being emptied and the catch processed on deck, a second apparatus may be towed to gather a second catch. The empty first apparatus may then be lowered for a further catch as the second apparatus is raised for emptying and processing.

In a final step shown in FIG. 37, the closed trailing end 102b of the apparatus is raised above the open leading end mouth 102a of the apparatus. The cable 55 is fully reeled in and apparatus 102 is then rolled up for storage around a drum 53 on the marine vessel 51. The apparatus preferably does not comprise any rigid stiffening components or diagonal or rigid grid components. That simplifies onboard handling or the apparatus and means the apparatus can be handled using existing equipment for handling traditional nets, for example rolled up around a drum on the rear of the vessel for compact storage. Alternatively the apparatus could be folded or otherwise rolled for storage.

An alternative embodiment of the method comprises inverting (i.e. turning inside-out) at least the substantially closed end 102b, 112b of the apparatus 102, 112 to drain at least some of any remaining aquatic animals out of the open end 102a, 112a of the apparatus. For example, the apparatus 102b, 112b may comprise one or more lines connected to the interior of the closed end 102b, 112b of the apparatus, extending through the interior of the apparatus, and out of the open end 102a, 112a of the apparatus. After the majority of the animals have been removed from the apparatus using the method of introducing liquid to flush out the animals as described above, the line(s) could be pulled forward to move the closed end 102b, 112b of the apparatus towards, and optionally through, the open end 102a, 112a of the apparatus, inverting at least the closed end of the apparatus. The inversion of the closed end 102b, 112b of the apparatus will cause liquid and remaining aquatic animals in the apparatus to move forward, so that remaining aquatic animals flow out of the open end 102a, 112a of the apparatus onto the vessel. That method could be performed while the apparatus 102, 112 is in the orientation shown in FIG. 26 or 28 for example.

With any of these alternatives for emptying remaining aquatic animals, because the remaining animals are emptied onto the vessel along with water, the water cushions the animals, reducing contact between animals as they are emptied. The water flowing out of the apparatus 102 can be used to flow the remaining catch into pounds or directly into the hold with minimal damage.

The apparatuses and methods described herein remove the majority of aquatic animals from the apparatus by introducing fluid flow into the apparatus and using the introduced flow of liquid to transport aquatic animals contained in the apparatus, out of the open end of the apparatus. That enables at least the majority of the aquatic animals to be removed from the apparatus via that fluid flow, rather than requiring the full apparatus to be lifted out of the water. The apparatuses and methods therefore disassociate the volume and potential catch size of the apparatuses from the stability and lift capacity of the marine vessel.

Preferred embodiments of the invention have been described by way of example only and modifications may be made thereto without departing from the scope of the invention.

The above described extracting method may be similarly used with an apparatus with an alternative baffle arrangement, for example, with an external baffle. Alternatively, the method may be used with an apparatus without a baffle or channel arrangement. Liquid or water may be delivered to an internal region of the apparatus proximal the closed end to apply a positive pressure to the region of the apparatus proximal the closed end, for example, using a hose with an outlet positioned proximal the closed end, to cause liquid flow toward the open end of the apparatus.

The method above describes emptying the harvested catch from the apparatus 1, 21, 102, 112 onto a marine vessel 51. Alternatively, the catch may be emptied to an alternative delivery zone such as an offshore holding facility, or directly onto a land-based area.

In some embodiments, the apparatus is an apparatus such as those described herein for harvesting aquatic animals. Alternatively the apparatus may be an apparatus for transporting aquatic animals, for example.

Through the use of lightweight strong composite materials for the apparatus body of apparatus 102, 112, very large apparatuses may be used to provide large catch capacities which are not restricted by marine vessel lifting capacity or stability. High water volume to aquatic animal ratios can be used to minimise animal-on-animal contact and damage.

Modifications may be made to one or more of water flow distribution, water flow rate, apparatus volume, and apparatus internal lining (e.g. a mesh liner to crowd fish to the surface) to control the proportion of lively, strong swimming aquatic animals that remain in the apparatus after the majority of the aquatic animals have been removed from the open end of the apparatus by introducing liquid into the apparatus through the channel.

Experimental Data

Water Tank Trials

To test and validate the method described above, simulations in a water tank were carried out using a scale model of the apparatus 102 shown in FIGS. 24 and 25. The model was constructed with a length L from the closed end 102b to the open end 102a of about 7945 mm, a diameter D of about 1471 mm, and a volume of about 2.2 m³. The model was approximately two-thirds of the size of an exemplary full scale embodiment.

The water tank tests were carried out using a 16 kW propeller pump in a 50,000 L capacity water tank. The pump was operated with a 250 litre per second output. The pump head was 1.450 m, and the pump current was between 14.0 A (7.9 kW) and 20.2 A (10.5 kW) (available pump current 30 A).

Water filled balloons and water bottles we used to simulate aquatic animals. The tests used the following targets:
Neutrally buoyant water filled balloons (n=10), average weight 1.60 kg.
Positively buoyant water filled balloons (n=10), average weight 1.42 kg, about 1% positive buoyancy.
Negatively buoyant water filled bottles (n=6) average weight 1.67 kg, about 2% negative buoyancy.

Over three clearance trials, the neutral and positively buoyant test targets started clearing from the apparatus an average of 5 seconds from the water reaching the working head. The final neutral and positively buoyant test targets cleared in an average time of 3 minutes and 32 seconds.

The negatively buoyant test bottles started clearing from the apparatus in an average time of 1 minute and 7 seconds, and the final negatively buoyant targets in 3 minutes and 46 seconds.

The flow rate for these tests was approximately 60 to 80 L/s. Approximately 240 to 260 L/s is theoretically available for the pump that was utilised. Therefore, the trial flow rates represent a conservative flow. Much higher rates of clearance would be possible with relatively modest power consumption and a potentially very compact pump footprint compared to conventional vacuum pump systems when the vessel is designed to accommodate the system.

Marine Voyage Trials and Observations

Marine voyage trails were carried out in New Zealand fisheries using the apparatus 112 shown in FIG. 31 as a cod end of a trawling apparatus. Following the trawl, the aquatic animals were emptied from the apparatus using the method described above, where water is introduced through the channel 116 to cause the aquatic animals to flow out the open end 112a of the apparatus.

When the apparatus was being trialled, video footage was taken of deck operations. The data in the following tables has been compiled from these videos. The ‘amount of fish flushed’ coming out of the open end 112a of the apparatus 112 and the amount of ‘remaining fish in apparatus’ are based on an estimate of the number of cases of fish this would equate to, where a case of fish weighs approximately 40 kg.

The ‘total catch size’ is taken from the Trawl, Catch, Effort and Processing Return (TCEPR) form that is filled in by the skipper after each tow.

TABLE 1
first voyage trial results

| | | | | | | Remaining | Remaining |
|---|---|---|---|---|---|---|---|
| | Total | | Flushing | Amount of | Fish | fish in | fish in |
| | catch size | Flush | period | fish flushed | flushing rate | apparatus | apparatus |
| Tow | (kg) | speed | (sec) | (kg) | (kg/min) | (kg) | (% by weight) |
| 2 | 2800 | Fast | 10 | 150 | 900 | 400 | 14.3 |
| | | Fast | 3 | 40 | 800 | | |
| 3 | 550 | Slow/med | 20 | 120 | 360 | No footage | No footage |
| 4 | 600 | Slow/med | 7 | 40 | 343 | 120 | 20.0 |
| 5 | 670 | | | | No footage | 120 | 17.9 |
| 6 | 1500 | Fast | 6 | 120 | 1200 | 250 | 16.7 |
| 7 | 600 | | | | No footage | 60 | 10.0 |
| 8 | 280 | Medium | 15 | 100 | 400 | No footage | No footage |
| 9 | 780 | Medium | 7 | 80 | 685 | 150 | 19.2 |
| Mean | | | | | 669.8 | | 16.3 |
| SEM* | | | | | 12.3 | | 0.8 |
| Min | | | | | 343 | | 10 |
| Max | | | | | 1200 | | 20 |

*SEM = standard error of the mean

TABLE 2
second voyage trial results

| | | | | | | Remaining | Remaining |
|---|---|---|---|---|---|---|---|
| | Total | | Flushing | Amount of | Fish | fish in | fish in |
| | catch size | Flush | period | fish flushed | flushing rate | apparatus | apparatus |
| Tow | (kg) | speed | (sec) | (kg) | (kg/min) | (kg) | (% by weight) |
| 1 | 630 | Fast | 5 | 80 | 960 | 160 | 25.4 |
| | | Slow | 15 | 40 | 160 | | |
| | | Slow/med | 6 | 40 | 400 | | |
| 2 | 320 | Fast | 11 | 160 | 872 | 90 | 28.1 |
| 4 | 3900 | Fast | 2 | 40 | 1200 | No footage | No footage |
| 8 | 3900 | Fast | 3 | 80 | 1600 | No footage | No footage |
| | | Med | 15 | 180 | 720 | | |
| 9 | 970 | Fast | 8 | 160 | 1200 | 80 | 8.2 |
| | | Fast | 4 | 80 | 1200 | | |
| | | Slow | 18 | 40 | 133 | | |
| Mean | | | | | 844.6 | | 20.6 |
| SEM | | | | | 42.3 | | 3.8 |
| Min | | | | | 133 | | 8.2 |
| Max | | | | | 1600 | | 28.1 |

During the marine voyage trials, the apparatus 112 performed well, showing the ability to flow fish in excellent condition into a sorting table on a deck of the marine vessel. The first species to be flushed out of the open end 112a of the apparatus 112 were buoyant snapper (SNA), gurnard (GUR), John Dory (JDO), and barracouta (BAR).

During the trails, the water flow rate into the apparatus 112 through the channel 116 was controlled with a remote control on the deck of the marine vessel. The pump had a designed maximum flow rate of about 250 litres per second. It was found that the 40% flow setting was enough to provide a constant overflow of buoyant fish onto the sorting table. A pattern of increasing the flow to 80-100% for a short period then reducing to 40-50% was established as the best method of flushing the non-buoyant fish out of the apparatus.

The rate at which fish could be flowed out of the open end 112a of the apparatus 112 could range from about 100 kg/min where fish are slowly metered out, through to about 1600 kg/min where fish came out very rapidly.

During the first voyage trials, approximately 10-20% of the catch by weight typically remained in the bottom of the apparatus 112 due to the formation of an eddy within the trailing end 112b of the apparatus body. Two of the second voyage trials had a higher remaining catch percentage by weight of about 25.4% and 28.1%. A small number of heavy and strong swimming fish such as kingfish can increase the percentage by weight of remaining catch.

In the trials, the species remaining in the apparatus after the liquid flushing method were strong swimming pelagics (kingfish (KIN), trevally (TRE), jack mackerel (JMA)), non-buoyant SNA, tarakihi (TAR), and dense fish (skates/rays, sharks). The fish remaining in the apparatus were typically in very good condition, with minimal external damage and the ability to swim strongly. They would therefore be particularly suitable for post-harvesting applications requiring live fish.

Although in the trials some of the catch remained in the apparatus after the liquid flushing method, it would be possible to remove the remaining fish from the apparatus 112 by using one of the methods described above; for example lifting the closed end 112b of the apparatus, inverting the closed end 112b of the apparatus, or pulling the partly-empty apparatus onto the vessel and then emptying the apparatus of remaining fish.

When the landed catch volume was less than 1 tonne, fish quality was found to be excellent and fish flowed out of the apparatus 112 evenly. When the landed catch volume was greater than 1 tonne in the trialled size of apparatus, a buoyant bolus of fish forms in the apparatus 112 with fish coming out in 100 kg pulses rather than flowing out. Fish quality can be reduced with larger catches due to fish-on-fish contact; however, the fish in the larger catches were still of good usable quality. The fish quality of larger catches could be improved by using a larger apparatus 102, 112.

1. A method for extracting aquatic animals from an apparatus containing aquatic animals, the apparatus comprising an apparatus body with an open end through which aquatic animals have entered the apparatus, a substantially closed end, and one or more side walls between the open end and the substantially closed end, wherein at least a major portion of the side wall(s) comprise a flexible membrane, and at least a major portion of the side wall(s) and the substantially closed end are substantially impervious to water; the method comprising:
arranging the apparatus with the open end of the apparatus positioned higher than the substantially closed end;
introducing a flow of liquid into an interior region of the apparatus proximal the substantially closed end; and
using the introduced flow of liquid to transport aquatic animals contained in the apparatus, out of the open end of the apparatus body.

2. A method as claimed in claim 1, wherein the apparatus comprises a baffle defining a channel having a channel inlet and a channel outlet, the channel outlet proximal the substantially closed end of the apparatus body; the method comprising:
introducing liquid into the channel via the channel inlet, thereby causing liquid to flow along the channel;
wherein the flow of liquid into the interior region of the apparatus proximal the substantially closed end is provided by way of the channel outlet.

3. (canceled)

4. A method as claimed in claim 2, wherein the channel inlet is positioned proximal the open end of the apparatus body, and wherein the channel is an elongate channel, and may extends along at least a major length of the apparatus body.

5. A method as claimed in claim 2, wherein liquid is introduced into the channel inlet by pumping water into the channel inlet from a pump.

6. A method as claimed in claim 5, wherein the channel inlet is positioned in an interior of the apparatus body.

7. (canceled)

8. A method as claimed in claim 6, wherein the channel inlet is positioned in the open end of the apparatus body, and wherein the method comprises inserting an outlet from the pump into the channel inlet and/or coupling the outlet from the pump to the channel inlet, through the open end of the apparatus body.

9. (canceled)

10. A method as claimed in claim 5, wherein the channel inlet is provided in the or one side wall of the apparatus, and wherein the method comprising inserting an outlet from the pump into the channel inlet and/or coupling the outlet from the pump to the channel inlet, from a side of the apparatus.

11. A method as claimed in claim 2, comprising varying a flow rate of liquid into the channel to vary the rate of extraction of aquatic animals or to control the type of aquatic animals that are extracted.

12. A method as claimed in claim 1, wherein the flow of liquid introduced into the interior region of the apparatus proximal the substantially closed end applies a positive pressure to the contents of the apparatus, resulting in a net flow of liquid from the substantially closed end of the apparatus to the open end.

13. (canceled)

14. (canceled)

15. A method of harvesting aquatic animals comprising:
providing an apparatus comprising a body with an open end, a substantially closed end, and one or more side walls between the open end and the substantially closed end, wherein at least a major portion of the side wall(s) comprise a flexible membrane, and at least a major portion of the side wall(s) and the substantially closed end are substantially impervious to water, wherein the apparatus forms at least a cod end portion of a harvesting apparatus for harvesting aquatic animals;
submerging the harvesting apparatus in a body of water and positioning and/or moving said harvesting apparatus such that there is water flow relative to the harvesting apparatus;
capturing aquatic animals in the harvesting apparatus while providing a relaxed low flow rate environment for the aquatic animals in the harvesting apparatus;
raising the harvesting apparatus while maintaining aquatic animals in a cod end portion of the apparatus, in a pool of water;
then extracting animals using the method as claimed in claim 1.

16. An apparatus for use with the method of claim 1, comprising:
an apparatus body having an open end through which aquatic animals can enter the apparatus, a substantially closed end and one or more side walls between the open end and the substantially closed end; and
a baffle defining a channel having a channel inlet and a channel outlet, the channel outlet being positioned more proximal the substantially closed end of the apparatus body than the channel inlet, wherein the channel is arranged for introducing a flow of liquid through the channel outlet into the apparatus body proximal the substantially closed end of the apparatus body, such that the introduced flow of liquid transports aquatic animals contained in the apparatus out of the open end of the apparatus body in use;
wherein at least a major portion of the side wall(s) comprise(s) a flexible membrane, and at least a major portion of the side wall(s) and the substantially closed end are substantially impervious to water

17. An apparatus as claimed in claim 16, wherein at least a major portion of the baffle comprises a flexible membrane that is substantially impervious to water.

18. An apparatus as claimed in claim 16, wherein the baffle is positioned in an interior of the apparatus body.

19. An apparatus according to claim 16, wherein the baffle is attached to one or more of the side wall(s) of the body.

20. (canceled)

21. An apparatus according to claim 16, wherein the baffle is movable between an inflated condition and a collapsed condition, and wherein a cross-sectional area of the channel is greater in the inflated condition of the baffle than in the collapsed condition of the baffle.

22. An apparatus according to claim 21, wherein in the collapsed condition the baffle is positioned against respective body side wall(s).

23. An apparatus according to claim 21, wherein in the inflated condition, the baffle is concave relative to the respective body side wall(s), and in the collapsed condition, the baffle is convex relative to the respective body side wall(s).

24. (canceled)

25. (canceled)

26. An apparatus according to claim 16, wherein the baffle and/or the channel is tapered inwards at or towards the channel outlet, and wherein a tapered portion proximal the channel outlet is configured to increase back pressure in the channel to maintain the baffle in the inflated condition.

27-30. (canceled)

31. An apparatus according to claim 16, wherein the apparatus further comprises an elongate lengthener portion attached to the apparatus body, wherein the lengthener portion has a leading end, a trailing end, and one or more side wall(s) between the leading end and the trailing end, wherein at least a major part of the side wall(s) comprise(s) a flexible membrane that is substantially impervious to water, and wherein the trailing end of the lengthener portion is operatively connected to the open end of the apparatus body.

32. An apparatus according to claim 31, wherein the elongate lengthener portion has a plurality of escapements through which water can pass from an interior of the apparatus to an exterior of the apparatus to cause a general reduction in the water flow rate inside the apparatus from the leading end of the elongate lengthener portion toward the substantially closed end of the apparatus body when the apparatus is submerged in a body of water and there is water flow relative to the apparatus.
